(19) United States
(12) Patent Application Publication
(10) Pub. No.: US 2017/0037218 A1
(43) Pub. Date: Feb. 9, 2017

(54) BIO-BASED HOT MELT ADHESIVES

(71) Applicant: 3M INNOVATIVE PROPERTIES COMPANY, St. Paul, MN (US)

(72) Inventors: Ignatius A. KADOMA, Cottage Grove, MN (US); Cheng-Chung CHANG, Rowland Heights, CA (US); Michael D. CRANDALL, North Oaks, MN (US); Yong K. WU, Woodbury, MN (US)

(21) Appl. No.: 15/300,858

(22) PCT Filed: Mar. 25, 2015
(86) PCT No.: PCT/US2015/022489

§ 371 Date: Sep. 30, 2016

Related U.S. Application Data
(60) Provisional application No. 61/972,790, filed on Mar. 31, 2014.

(51) Int. Cl. C08K 5/10; C09J 167/04

(52) U.S. Cl. CPC C08K 5/10; C09J 167/04; C08K 2201/018

(57) ABSTRACT

A hot melt adhesive including a poly(lactide) homopolymer or copolymer with a molecular weight of about 1000 to about 40000 Daltons; and a plasticizer including an ester with about 50% to about 99% bio-based content; wherein the viscosity of the hot melt adhesive composition is about 500 to about 15,000 cPs at 350 F, and wherein the hot melt adhesive composition is substantially free of tackifying resins.

### BACKGROUND

Hot melt adhesives (HMAs) are solids at room temperature, but when heated form a liquid adhesive layer that cools and bonds rapidly to a substrate. HMAs can be useful for high speed manufacturing and applications that require bonding versatility, large gap filling, and minimal shrinkage. HMAs do not require a carrier fluid such as an organic solvent or water, which eliminates the need for drying the liquid adhesive layer once it is applied to a substrate. Elimination of the drying step reduces solvent usage, increases production line speeds, and lowers transportation costs.

HMA compositions have historically been based on petroleum-derived polymers, and these compositions are further tackified, plasticized, and reinforced with a variety of resins, oils and waxes that can be derived from both petroleum and naturally occurring feedstocks such as wood, gum and tall oil rosin, and terpenes. These HMA compositions are subject to the cyclical price cycles common to all petroleum-derived materials, and also are generally very resistant to degradation once the articles employing them (such as cardboard boxes and the like) are disposed.

HMA compositions made from raw materials derived from renewable, natural resources can be composted or degrade naturally after coming in contact with the soil. For example, HMA compositions prepared from homopolymers or copolymers of poly(lactide) (the bimolecular cyclic ester of lactic acid), also referred to herein as PLA, can be useful in many bonding applications.

### SUMMARY

The present disclosure is directed to HMA compositions that, in various embodiments, include at least 50 wt %, or at least 75 wt %, or at least 85 wt %, or at least 95 wt %, of components derived from renewable, natural resources. The HMA compositions utilize raw materials that demonstrate some level of natural degradation when composted or contacted with soil. The HMA compositions utilize poly(lactic acid), which is derived from a non-petroleum feedstock, as a base polymer. Poly(lactic acid) polymers have a high molecular weight previously considered unsuitable for use in HMA compositions, and for use in these applications required compounding with significant amounts of petroleum-derived tackifying resins, diluents or other modifiers.

In one aspect, the present disclosure is directed to a method for modifying the molecular weight of poly(lactic acid) polymers using a molecular weight reducing compound such as a weak acid, an alcohol, a base, an amine, or a combination thereof, which can provide a low melt viscosity material that is suitable for HMA applications.

The method of this disclosure differs from conventional techniques in which HMA compositions are made from monomeric lactide with comonomers to build up molecule chains, or rely on high molecular weight base polymers, which can require significant amounts of tackifier and other modifying additives from non-renewable sources to achieve a desired level of HMA performance. The method of this disclosure can produce base polymers with tailored molecular weight distribution, which in some embodiments require no tackifier, and in some embodiments can require fewer modifying additives to achieve good performance as a HMA.

In another aspect, the present disclosure is directed to low-melt viscosity HMA compositions that have good hot tack characteristics and require either no tackifiers or a reduced amount of tackifying agents/compounds. The HMA compositions require a minimum amount of plasticization and/or diluents to achieve the desirable wetting characteristics typical of a HMA at application temperatures of 300-375° F. (150-190° C.).

In one aspect, the present disclosure is directed to a hot melt adhesive including a poly(lactide) homopolymer or copolymer with a molecular weight (Mn) of about 1000 to about 40000 Daltons; and a plasticizer including an ester with about 50% to about 99% bio-based content; wherein the viscosity of the hot melt adhesive composition is about 500 to about 15,000 cPs at 350° F., and wherein the hot melt adhesive composition is substantially free of tackifying resins.

In yet another aspect, the present disclosure is directed to a hot melt adhesive including 60 wt % to 99 wt % of a poly(lactide) homopolymer or copolymer with a molecular weight of about 1000 to about 40000 Daltons; 1 wt % to 40% wt % of a plasticizer including an ester with about 50% to about 99% bio-based content; and 1 wt % to 25 wt % of an epoxy resin.

In another aspect, the present disclosure is directed to a hot melt adhesive composition including 60 wt % to 99 wt % of a poly(lactide) homopolymer or copolymer; 1 wt % to 40% wt % of a plasticizer including an ester with about 50% to about 99% bio-based content; 0 wt % to 25 wt % of an epoxy resin; and 0.1 wt % to 10 wt % of a molecular weight reducing compound selected from weak acids, amines, strong bases, alcohols, lewis acids, and combinations thereof, wherein the hot melt adhesive is substantially free of tackifying resins.

In yet another aspect, the present disclosure is directed to a method for making a hot melt adhesive, including heating to a temperature of 180° C. to 210° C. a hot melt adhesive composition including 60 wt % to 99 wt % of a poly(lactide) homopolymer or copolymer; 1 wt % to 40% wt % of a plasticizer including an ester with about 50% to about 99% bio-based content; and 0.1 wt % to 10 wt % of a molecular weight reducing compound selected from weak acids, amines, lewis acids, and combinations thereof.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a plot of the melt viscosity measurements of the HMA composition of Example 1.

FIG. 2 is a plot of the molecular weight distribution of the HMA composition of Example 1 using size exclusion chromatography (SEC).

FIG. 3 is a plot of the melt viscosity measurements of the HMA composition of Example 2.

FIG. 4 is a plot of the molecular weight distribution of the HMA composition of Example 2 using SEC.

FIG. 5 is a plot of the melt viscosity measurements of the HMA composition of Example 3.

FIG. 6 is a plot of the molecular weight distribution of the HMA composition of Example 3 using SEC.

FIG. 7 is a plot of the melt viscosity measurements of the HMA composition of Example 4.

FIG. 8 is a plot of the molecular weight distribution of the HMA composition of Example 4 using SEC.

FIG. 9 is a plot of the melt viscosity measurements of the HMA composition of Example 5.

FIG. 10 is a plot of the molecular weight distribution of the HMA composition of Example 5 using SEC.

FIG. 11 is a plot of the melt viscosity measurements of the HMA composition of Example 6.

FIG. 12 is a plot of the molecular weight distribution of the HMA composition of Example 6 using SEC.

FIG. 13 is a plot of the melt viscosity measurements of the HMA composition of Example 7.

FIG. 14 is a plot of the molecular weight distribution of the HMA composition of Example 7.

FIG. 15 is a plot of the melt viscosity measurements of the HMA composition of Example 8.

FIG. 16 is a plot of the molecular weight distribution of the HMA composition of Example 8 using SEC.

FIG. 17 is a plot of the melt viscosity measurements of the HMA composition of Example 9.

FIG. 18 is a plot of the molecular weight distribution of the HMA composition of Example 9 using SEC.

FIG. 19 is a plot of the melt viscosity measurements of the HMA composition of Example 10.

FIG. 20 is a plot of the molecular weight distribution of the HMA composition of Example 10 using SEC.

FIG. 21 is a plot of the melt viscosity measurements of the HMA composition of Example 11.

FIG. 22 is a plot of the molecular weight distribution of the HMA composition of Example 11 using SEC.

FIG. 23 is a plot of the melt viscosity measurements of the HMA composition of Example 12.

FIG. 24 is a plot of the molecular weight distribution of the HMA composition of Example 12 using SEC.

FIG. 25 is a plot of the melt viscosity measurements of the HMA composition of Example 13.

FIG. 26 is a plot of the molecular weight distribution of the HMA composition of Example 13 using SEC.

FIG. 27 is a plot of the melt viscosity measurements of the HMA composition of Example 14.

FIG. 28 is a plot of the molecular weight distribution of the HMA composition of Example 14 using SEC.

FIG. 29 is a plot of elastic modulus (G′) vs. temperature for the HMA compositions of Examples 1-2 and various neat PLA polymers and Ethylene Vinyl Acetate (EVA) HMA compositions.

FIG. 30 is a plot of melt viscosity measurements for the HMA composition of Example 15.

FIG. 31 is a plot of melt viscosity measurements for the HMA composition of Example 16.

FIG. 32 is a plot of melt viscosity measurements for the HMA composition of Example 17.

Like symbols in the drawings indicate like elements.

### DETAILED DESCRIPTION

In one aspect, the present disclosure is directed to HMA compositions including a polylactide compound (the bimolecular cyclic ester of lactic acid, also referred to herein as PLA) or copolymers thereof with other lactones such as glycolide and caprolactone, a plasticizer, a weak organic acid, and optional additives. In some embodiments, the HMA composition is substantially free of tackifying resins, which in this application means that the HMA composition includes less than 5 wt %, or less than 1 wt %, or less than 0.5 wt %, or less than 0.1 wt % of tackifying resin, or 0% tackifying resins. In other embodiments intended for heavy-duty bonding, the HMA composition can include less than 25 wt %, or less than 15 wt %, or less than 10 wt % of an epoxy tackifying resin. The term tackifying resin as used herein means a material included in the HMA composition to enhance the tack, or stickiness, or adhesion to a substrate. In addition to enhancing adhesion, the tackifying resin may cause the HMA composition to harden faster, or increase the temperature at which hardening occurs, thus building cohesive strength rapidly in the HMA product.

The major component of the HMA composition, which is present in an amount of about 60 wt % to about 99 wt % of the composition, includes a homo- or copolymer of poly(lactic acid), referred to herein generally as PLA:

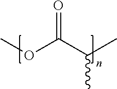

Lactide is a chiral molecule and exists in two distinct optically active forms, L-lactide and D-lactide, which can be polymerized to form a crystalline polymer. Polymerization of a racemic mixture of L- and D-lactide monomeric units forms poly-D,L-lactide (PDLLA), which is amorphous and has a glass transition temperature of 55-60° C. The degree of crystallinity in the poly(lactide) polymer also can be tuned by altering the ratio of D to L enantiomers within the polymer. Selection of the PLA stereochemistry can have a major effect on polymer properties, processability and biodegradability. In some embodiments, poly (L-lactide) or PLLA is used in the HMA precursor composition because it breaks down into L(+)-lactic acid units, a naturally occurring stereoisomer, and would be expected to degrade more quickly in the environment.

Suitable polylactide polymers can include, for example, homopolymers or copolymers made up of (L-lactide), (D-lactide), and (meso-lactide) monomeric units. As noted above, while poly(D,L-lactide) and poly(meso-lactide) are essentially amorphous, poly(L-lactide, PLLA) or poly(D-lactide, PDLA) are crystalline in nature and have a crystalline melting point of about 186° C., depending on molecular weight and stereopurity. In some embodiments, the PLA polymer in the HMA precursor composition includes a predominant amount of (L-lactide) and (D-lactide) monomeric units, and in some embodiments the PLA polymer is a crystalline homopolymer or copolymer including (L-lactide) and (D-lactide) monomeric units. In other embodiments, the PLA polymer is a crystalline homopolymer including (L-lactide) monomeric units.

In some non-limiting embodiments, suitable PLAs for use in the HMA composition have a number average molecular weight (Mn) of about 100,000 to about 200,000 Daltons, and a viscosity of about 1×10⁶ cP at 350° F. (177° C.). In this application, all molecular weights refer to number average molecular weight (Mn), unless otherwise designated.

For example, the poly(lactide) polymers may be prepared by ring-opening polymerization of the bimolecular cyclic ester of lactic acid with acid or base catalysts such as PbO, SnCl₂, SnCl₄, ZnCl₂, SbF₅, Sb₂O₃, or triethylamine using solution, precipitation or melt processes. Alternatively, the poly(lactide) polymers may be obtained commercially from, for example, Nature Works, LLC, Minnetonka, Minn., under the trade designations PLA 4060D and 6252D, or from Sigma Aldrich Corp., St. Louis, Mo., under the trade designation RESOMER, including RESOMER 206, 202, and 203.

In addition to the homopolymers and copolymers of poly(L-lactide), poly(D-lactide), poly(D,L-lactide), and poly(meso-lactide) referred to above, suitable polymers for use in the HMA composition may also be prepared by copolymerization of polylactides with other lactones such as glycolide or caprolactone.

Both L- and DL-lactides can be used for co-polymerization, and the ratio of lactone to lactide at different compositions allows control of the degree of crystallinity of the resulting copolymers:

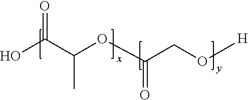

Suitable poly(D,L-lactide-co-glycolide) polymers containing equimolar amounts of the lactide and glycolide components are available from Sigma Aldrich under the trade designation RESOMER, including RG502, 503, 504, 505 and 506. In addition, poly(D,L-lactide-co-glycolide) polymers such as RESOMER RG 653 (including 65% of the lactide component), or RESOMER RG752, 755 and 756 (containing 75% of the lactide component), as well as RESOMER 858 (contains 85% lactide) are also suitable for use in the HMA composition.

The HMA composition further includes about 0.1 wt % to about 40 wt %, or about 1 wt % to about 20 wt %, based on the total weight of the composition, of a plasticizer, which in some embodiments is a bio-based plasticizer. In this application the term plasticizer refers to a material that increases the flexibility and/or toughness of the final HMA product by solvation of the poly(lactide) base polymer. In this application, the term bio-based means that the plasticizer includes more than 50% and up to 100% of materials that are biodegradable and/or are made from renewable materials that are not derived from petroleum.

In some embodiments, the plasticizer should be used in an amount sufficient to reduce the viscosity of the HMA composition to about 500 to about 15,000 cPs, or from about 800 to about 3000 cPs, at 350° F. (177° C.). Useful commercially available bio-based plasticizers include, but are not limited to, those available under the following trade designations: CITROFLEX 2, CITROFLEX A-2, CITROFLEX 4 and CITROFLEX A-4 from Morflex Inc. (Greensboro, N.C.); ester plasticizers from HallStar, Chicago, Ill. such as HALLGREEN R-3000, R-3010, R-3020, R-4010, R-4028, R-8010, and R-9010; and SGP9300D from Segetis, Golden Valley, Minn.

The HALLGREEN bio-based plasticizers are certified by the U.S. Department of Agriculture as a USDA Bio-based Product as defined under the USDA BioPreferred program created by the Farm Security and Rural Investment Act of 2002 (2002 Farm Bill), and expanded by the Food, Conservation, and Energy Act of 2008 (2008 Farm Bill). For example, the HALLGREEN plasticizers are esters with about 50% to about 100%, or about 50% to about 99%, bio-based content, which means that the esters are composed of and/or derived primarily from agricultural, forestry, or marine materials, and would be expected to degrade naturally in the environment.

The bio-based plasticizers may be used alone or in combination with other petroleum-derived plasticizers, but it is preferred that the amount of petroleum-based plasticizer be limited to preserve the biodegradable nature of the HMA compositions. Suitable additional plasticizers include, but are not limited to, for example, SANTICIZER 160 and SANTICIZER 154 t-butyl diphenyl phosphate from Monsanto (St. Louis, Mo.); DYNACOL 720 liquid plasticizer from Degussa (Piscataway, N.J.); liquid polymeric plasticizers from C.P. Hall (Chicago, Ill.); BENZOFLEX 352 1,4-cyclohexane dimethanol dibenzoate, BENZOFLEX 50 diethylene glycol/dipropylene glycol dibenzoate, BENZOFLEX P200 polyethylene glycol dibenzoate, BENZOFLEX 9-88 and BENZOFLEX 2088 dipropylene glycol dibenzoates, BENZOFLEX 400 polypropylene glycol dibenzoate, BENZOFLEX 2-45 diethylene glycol dibenzoate having from 0.5 to 0.95 mole faction esterified hydroxyl groups all from Velsicol (Rosemont, Ill.); PYCAL 94 phenyl ether of PEG from ICI (Wilmington, Del.), MACOL 206 EM ethoxylated bis phenol A from PPG Industries (Pittsburgh, Pa.), Sulfonic DNP dionyl phenol ethoxylates from Huntsman Chemical Corp. (Houston, Tex.); UNIPLEX 280 sucrose benzoate and UNIPLEX 214 and UNIPLEX 108 toluene sulfonamides from Unitex Chemical Corp. (Greensboro, N.C.); KETJENFLEX 8 from Akzo Nobel (Chicago, Ill.); and HERCOLYN D methyl ester of hydrogenated rosin from Hercules (Wilmington, Del.);and polyethylene glycols available from Dow (Midland, Mich.) under the trade designation CARBOWAX SENTRY, as well as vegetable and animal oils such as glyceryl esters of fatty acids and polymerization products thereof.

The HMA composition further includes about 0.1 wt % to about 10 wt %, based on the total weight of the composition, of at least one molecular weight reducing compound. The molecular weight reducing compound may be selected from any compound or combination of compounds that reduces the molecular weight of the poly(lactic acid) polymer or copolymer when employed with the plasticizers listed above.

In some embodiments, the molecular weight reducing compound reduces the molecular weight of the poly(lactic acid) polymer to provide a HMA composition with sufficiently low melt viscosity to function as a HMA. In some embodiments, the molecular weight reducing compound reduces the molecular weight (Mn) of the poly(lactic acid) homopolymer or copolymer in the HMA precursor composition to about 1000 to about 40,000 Daltons, or about 1000 to about 20,000 Daltons.

In some embodiments, the molecular weight reducing compound reduces the viscosity of the HMA composition to about 500 to about 15,000 cPs, or about 800 to about 2000 cPs, at 350° F. (177° C.).

In one embodiment, the molecular weight reducing compound is a weak organic or inorganic acid. Suitable weak organic acids include, but are not limited to, citric acid, oxalic acid, adipic acid, undecanoic acid, p-toluenesulfonic acid, stearic acid, and combinations thereof. Suitable weak inorganic acids include, but are not limited to, phosphoric acid, boric acid, Lewis acids such as, for example, MgCl₂, and the like. In various embodiments, the molecular weight reducing compound can be a strong base such as, for example, sodium hydroxide (NaOH), Ca(OH)₂, Mg(OH)₂, an alcohol such as, for example, undecan-1-ol, or an amine such as, for example, diethanolamine or triethanolamine, and combinations thereof.

To build cohesive strength, increase hardening rate, or increase hardening temperature in heavy-duty bonding applications, in some embodiments the HMA composition can include about 1 wt % to about 20 wt %, or about 5 wt % to about 15 wt %, or about 8 wt % to about 10 wt % of a tackifying resin to enhance crosslinking. Suitable resin crosslinkers include, for example, di- and polyepoxides that are capable of reacting with the hydroxyl and carboxylic acid end groups of the low molecular weight PLA, as well as di- and poly carbonates and anhydrides, and combinations thereof. Suitable examples include di- and polyepoxides such as glycidal ethers of bisphenol A, bisphenol F, bisphenol M, Novolac, melamines, polyglycols, and their modified derivatives, and epoxides of polyolefins and vegetable oils. Di- and polyanhydrides, di- and polycarbonates, methylolated ureas and amines and other PLA reactive chain extenders may also be used.

For example, in some embodiments, suitable epoxides can include bisphenol A diglycidyl ether of the formula below, wherein n denotes the number of polymerized subunits and is about 0 to about 25:

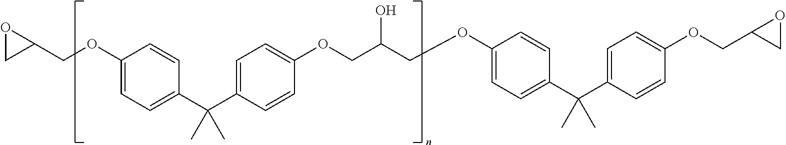

In some embodiments, the epoxide may be bisphenol F diglycidal ether epoxy resin:

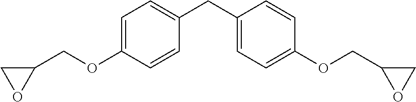 [SMILES: c1cc(OCC2CO2)ccc1Cc1ccc(OCC2CO2)cc1]

or an epoxidised novolac, such as an epoxy phenol novolac and epoxy cresol with typical mean epoxide functionality of around 2 to 6:

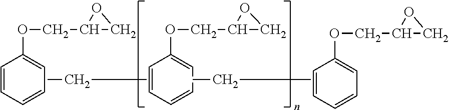

In other example embodiments, glycidyl epoxy resins, cycloaliphatic epoxides, and diepoxides such as the following may be used:

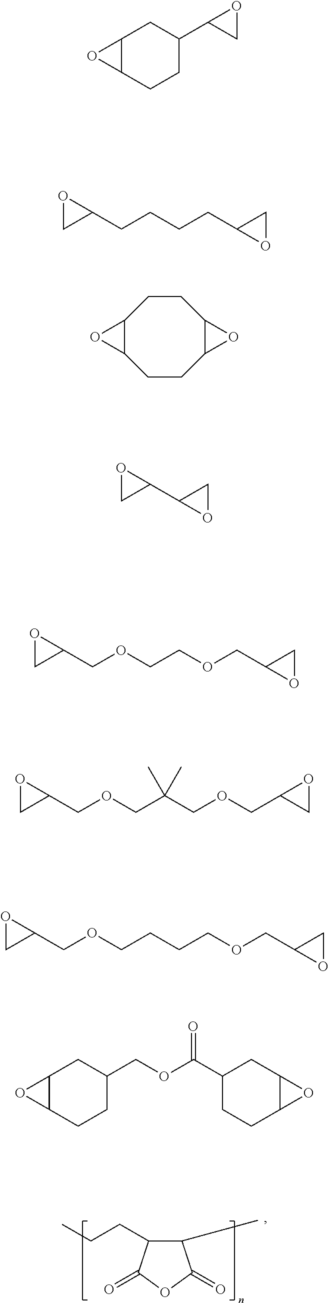

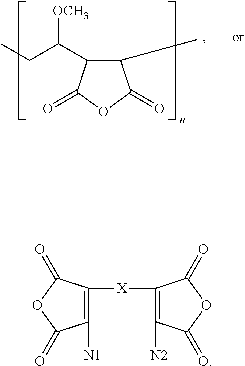

The epoxy resins can be liquid, solid, or a combination thereof, and include, but are not limited to, the epoxies available under the trade designation EPON from Momentive, Columbus, Ohio. Suitable examples include, but are not limited to, difunctional bisphenol A/epichlorohydrin derived liquid epoxy resins such as EPON 828, solid bisphenol-A/epichlorohydrin resins such as EPON 2004, and combinations thereof.

In various embodiments, the PLA can be heated to about 180° C. to about 195° C. in the presence of the molecular weight reducing compounds listed above, and the tackifiers can be added to allow them to react before or after adding plasticizers. In various embodiments, the HMAs prepared in this manner can have better adhesion and cohesion forces with somewhat better thermal stabilities.

The HMA composition can optionally further include wax diluents to reduce the melt viscosity or cohesive characteristics of the HMA without appreciably decreasing their adhesive bonding characteristics. These waxes are often used in adhesives which do not exhibit pressure sensitive properties. Suitable waxes include 12-hydroxystearamide wax, hydrogenated castor oil, oxidized synthetic waxes, poly(ethylene oxide) having a weight average molecular weight above about 1000 and functionalized synthetic waxes such as carbonyl containing Escomer H101 from Exxon. It should be recognized that some HMA compositions may contain both wax and plasticizer components so that the presence of one or the other is not mutually exclusive.

The HMA composition can further optionally include stabilizers or antioxidants such as, for example, high molecular weight hindered phenols and multifunctional phenols such as sulfur and phosphorous-containing phenols. Representative hindered phenols include: 1,3,5-trimethyl-2,4,6-tris(3,5-di-tert-butyl-4-hydroxy-benzyl)benzene; pentaerythritoltetrakis-3-(3,5-di-tert-butyl-4-hydroxyphenyl)propionate; n-octadecyl 3,5-di-tert-butyl-4-hydroxyphenyl) propionate; 4,4′-methylenebis (2,6-di-tert-butylphenol); 4,4′-thiobis (6-tert-butyl-o-cresol); 2,6-di-tert-butylphenol; 6-(4-hydroxyphenoxy)-2,4-bis(n-octylthio)-1,3,5-triazine; di-n-octadecyl-3,5-di-tert-butyl-4-hydroxy-benzylphosphonate; 2-(n-octylthio)-ethyl 3,5-di-tert-butyl-4-hydroxybenzoate; and sorbitol hexa[3-(3,5-di-tert-butyl-4-hydroxyphenyl)propionate].

Optional additives may be incorporated into the HMA compositions to modify certain properties thereof. Among these additives may be included colorants such as titanium dioxide; and fillers such as talc and clay, and the like.

There may also be present in the HMA composition small amounts (e.g., less than about 20% by weight, and preferably 5 to 20% by weight) of certain thermoplastic polymers such as ethylene vinyl acetate containing 12 to 50% vinyl acetate, ethylene acrylic acid, ethylene methyl acrylate and ethylene n-butyl acrylate copolymers as well as caprolactone polymers. In some embodiments, these polymers can impart flexibility, toughness and strength to the HMA. Alternatively and in particular, it may be desirable to incorporate into the HMA composition up to 20% by weight of certain hydrophilic polymers such as polyvinyl alcohol, hydroxyethyl cellulose, polyvinyl methyl ether, poly(ethylene oxide), or poly (hydroxy butyrate/hydroxy valerate), which can increase the water sensitivity of the adhesives as desired for some applications.

In another aspect, the present disclosure is directed to a HMA derived from the HMA compositions described above. In some embodiments, the viscosity of the HMA is about 500 to about 15,000 cPs, or about 800 to about 2000 cPs, at 350° F. (177° C.). In some embodiments, the molecular weight of the poly(lactic acid) homopolymer or copolymer in the HMA is about 1000 to about 40,000 Daltons, or about 1000 to about 20,000 Daltons.

In one example embodiment, the HMA includes 10 wt % to 99 wt % of a poly(lactide) homo- or copolymer (L-, D- and -D, L or meso or mixtures thereof) with a molecular weight of about 1000 to about 40,000 Daltons, or about 1000 to about 20,000 Daltons; 1 wt % to 50 wt % of a bio-based ester plasticizer; 0 wt % to 20 wt % of an epoxy resin, 0 wt % to 30 wt % of a wax diluents, and 0 wt % to 3 wt % of a stabilizer.

In another example embodiment, a non-pressure sensitive HMA composition can be prepared using 20 wt % to 70 wt % of the polylactide homo- or copolymer with a molecular weight of about 1000 to about 40,000 Daltons, or about 1000 to about 20,000 Daltons; 1 wt % to 20 wt % of a bio-based plasticizer; 0 wt % to 10 wt % of an epoxy resin; and 0 wt % to 3 wt % of a stabilizer.

Lower levels of plasticizer may also be employed to produce adhesives useful for various end uses such as in construction adhesives for disposable products where some initial degree of tack is needed but no residual pressure sensitive properties are required.

In yet another example embodiment, non-pressure sensitive adhesives can be prepared using 20 wt % to 98 wt % of the polylactide homo- or copolymer with a molecular weight of about 1000 to about 40,000 Daltons, or about 1000 to about 20,000 Daltons; 1 wt % to 20 wt % plasticizer, 0 wt % to 10 wt % epoxy resin, and 0 wt % to 3 wt % of a stabilizer.

In yet another aspect, the present disclosure is directed to a method for making a HMA from the HMA compositions described above. In this method the poly(lactic acid) polymer, plasticizer, optional tackifier, and any additional optional additives are placed in a mixer with stirring and heated to a temperature of about 180° C. to about 210° C., or about 190° C. to about 200 C. The weak organic acid is added, and the mixture is heated for a time sufficient to form a smooth, homogeneous HMA with a desired viscosity. Reaction times may vary widely, but a time of about 0.1 hours to about 2 hours, or about 1 hour to 2 hours, is typically used to form the HMA.

The HMA may optionally be formed into sticks, pellets, blocks, pillows and the like.

The HMAs disclosed herein may be employed in a wide variety of uses, including packaging and carton sealing applications, bookbinding operations, or laminating tissue and/or screen-reinforced tissue layers such as are used in individual or roll use applications as in wipers, paper towels, toilet tissue and other consumer or industrial end uses. The adhesives may be used in the assembly or construction of various disposable applications including, but not limited to, sanitary napkins, disposable diapers, hospital gowns, bed pads and the like. In particular, adhesives are useful for the assembly of disposable articles using multi-line construction techniques wherein at least one flexible film substrate is bonded to at least one tissue, non-woven, polyolefin or other flexible polymeric film substrate. In addition, the adhesives may be useful in the bonding of elastic to polyethylene, polypropylene or non-woven substrate so as, for example, to impart elongation resistant gathers thereto. The adhesive may also be utilized in less demanding disposable construction applications such as for end or perimeter sealing.

The compositions and method of the present disclosure will now be further illustrated by the following non-limiting examples.

### EXAMPLES

The PLAs were obtained from NatureWorks, Minnetonka, Minn.

The Hallgreen plasticizers were obtained from HallStar, Chicago, Ill.

The SGP9300D plasticizer was obtained from Segetis, Golden Valley, Minn.

The epoxies were obtained from Momentive, Columbus, Ohio.

Size Exclusion Chromatography (SEC) was used for measuring molecular weight distribution as follows: Approximately 50 mg of test material was dissolved in 10 mL of dichloromethane. The resulting solution was run through a 0.45 micron syringe filter and analyzed by SEC. The SEC system was operated under the following conditions:

Sample: 50 μL, Injection @ 5 mg/mL Dichloromethane (sample filtered through 0.45 micron membrane)

Mobile Phase: Dichloromethane, ACS HPLC Grade

Flow Rate: 1.0 mL/min

System: Enterprise (Agilent 1100 pump/autosampler, MAID #1215)

Detector: Agilent 1260 Refractive Index Detector (MAID #1229)

Columns: 2 PLGel 10 microns Mixed-B (nominal MW range 500-1×10⁷ Daltons), 1 PLGel 5 microns Mixed-D (nominal MW range 200-400,000 Daltons), all are 7.8×300 mm. Columns were maintained at 40° C.

Standards: Polystyrene, narrow dispersity; ranging from 6.87×10⁻⁶-580 Mp; (3^{rd} order polynomial fit)

Syringe filter type: 0.45 micron PTFE

Molecular weight values were determined by calibrating the system against narrow molecular weight polystyrene standards. Relative molecular weight and polydispersity values were reported. Also reported are plots of the chromatograms of each example. Each result is the average of duplicate injections. For clarity, only the first injection of the sample is shown in the chromatogram.

An AR-G2 rheometer from TA instruments (New Castle, Del.) was used for monitoring melt viscosity of the starting material and reaction mixtures. About 3 gms of test material was set between two circular parallel plates of the rheometer at a gap of 1.1 mm. The top plate measured 20 mm in diameter while the bottom plate measured 100 mm in diameter. The bottom plate was a peltier temperature controlled plate and held at a steady temperature of 177° C. Using the top plate, each sample was subjected to a fixed 5% small amplitude oscillatory stress varying in frequency from 1 Hz to 10 Hz. The response of the test material to this oscillatory stress was then reported as the complex viscosity in units of Pa·sec.

### Example 1

### Preparation of PLA Hot Melt Adhesive Composition 162455-65-2

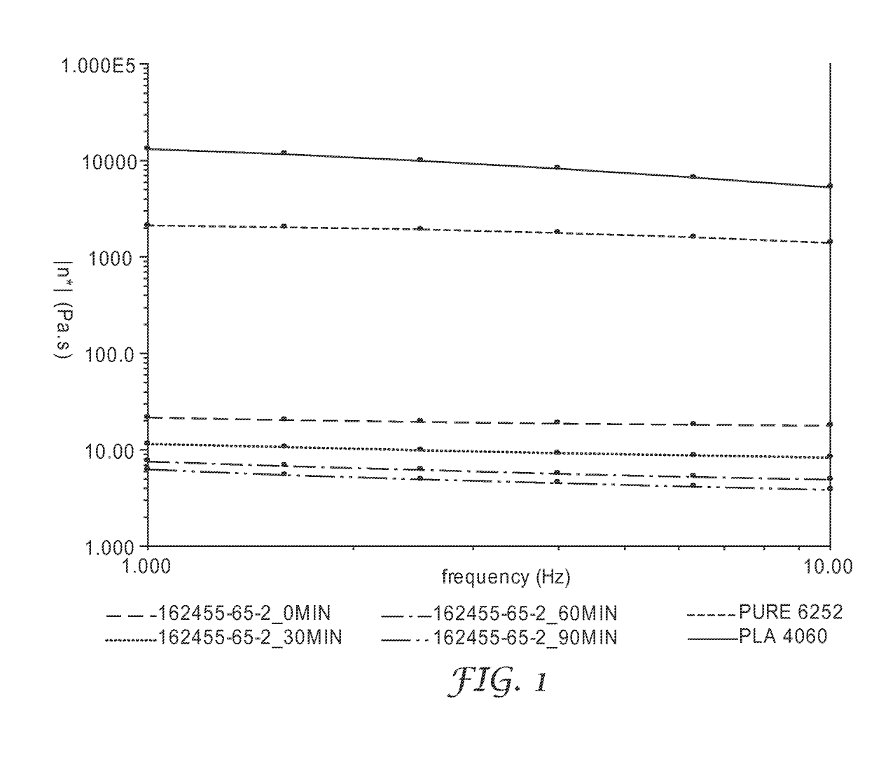

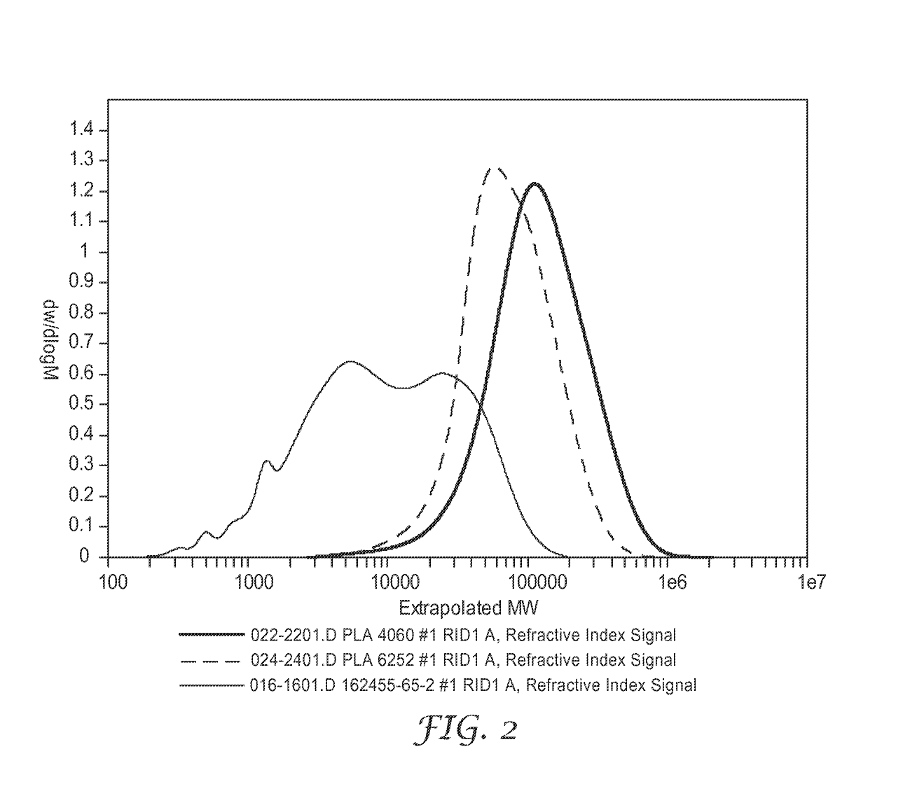

To a 500 ml three-necked flask equipped with mechanical stir, thermometer, and condenser, 144 g of Hallgreen R8010 plasticizer (Hallstar, Chicago, Ill.) was charged and heated to 190° C. Then 76 g of PLA 4060D was slowly added and followed by 152 g of PLA 6252D. After the content became a solution, 1.9 g of citric acid was slowly introduced and allowed the mixture to react with agitation. A small sample was removed and the viscosity was monitored by a rheometer model AR-G2 from TA instruments (New Castle, Del.) at 177° C. until reached desired viscosity of 5,000-10,000 cps. Then 3.8 g of calcium carbonate was added and allow reacting for another hour before stopped. The resulting polymer was evaluated for hot melt adhesive application. The melt viscosity measurements and SEC analysis results are summarized in FIG. 1 and FIG. 2. Also reported are the relative molecular weight and polydispersity values in Table 1.

TABLE 1

| Sample | | | | |
|---|---|---|---|---|
| Name | Mw | Mn | Mz | Polydispersity |
| 162455-65-2 | 1.867E+04 | 4.152E+03 | 4.518E+04 | 4.50 |
| PLA 4060 | 1.549E+05 | 7.785E+04 | 2.630E+05 | 1.99 |
| PLA 6252 | 9.364E+04 | 5.314E+04 | 1.524E+05 | 1.76 |

The results indicated the melt viscosity of PLA was reduced by the plasticizer from well over a million to 110,000 and further effectively reduced by the reaction with citric acid to about 5,000 in 90 minutes of reaction time.

### Example 2

### Preparation of PLA Hot Melt Adhesive Composition 162455-91-1

To a 500 ml three-necked flask equipped with mechanical stir, thermometer, and condenser, 95 g of Hallgreen R8010 plasticizer was charged and heated to 190° C. Then 93.1 g of PLA 4060D was slowly charged and followed by 186.2 g of PLA 6252D. After the content became to a solution, 1.9 g of oxalic acid was slowly introduced and allowed the mixture to react with agitation. A small sample was removed and the viscosity was monitored by a rheometer model AR-G2 from TA instruments (New Castle, Del.) at 177° C. until reached the desired viscosity of 2,000-3,000 cps. Then 3.8 g of calcium carbonate was added and allowed to react for another hour before being stopped.

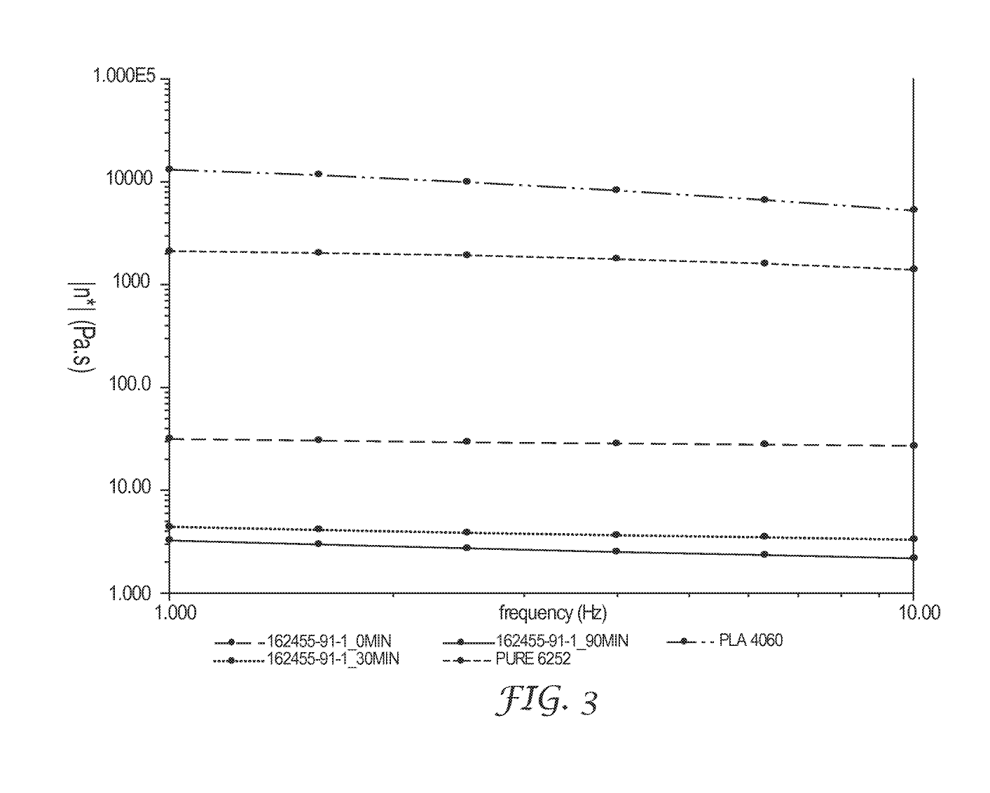

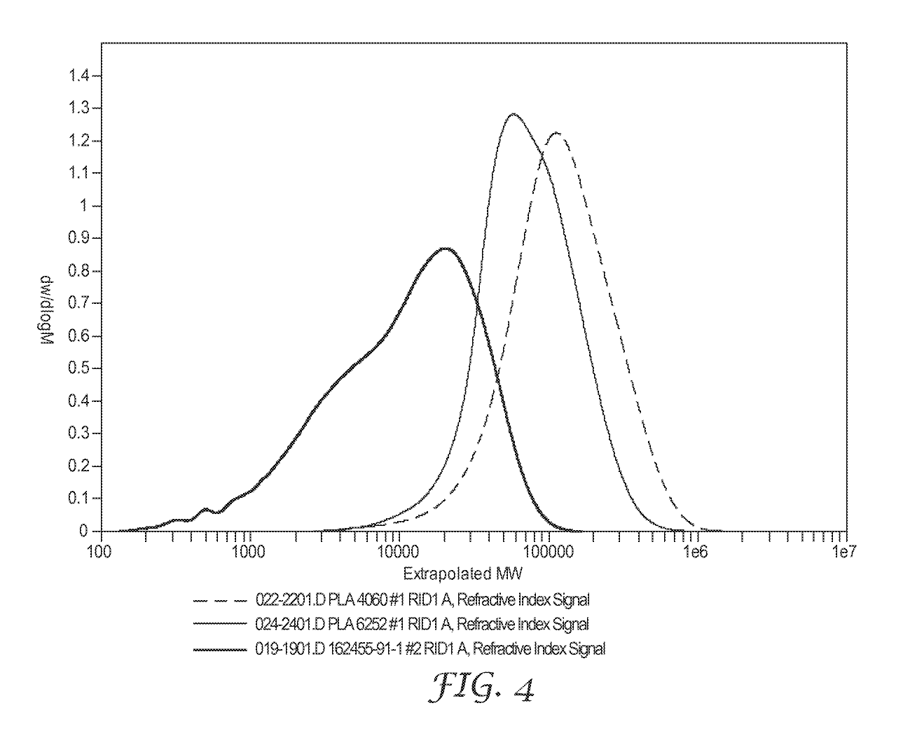

The melt viscosity measurements and SEC analysis results are summarized in FIG. 3 and FIG. 4, respectively. Also reported are the relative molecular weight and polydispersity values in Table 2.

TABLE 2

| Sample | | | | |
|---|---|---|---|---|
| Name | Mw | Mn | Mz | Polydispersity |
| 162455-91-1 | 1.741E+04 | 4.613E+03 | 3.344E+04 | 3.78 |
| PLA 4060 | 1.549E+05 | 7.785E+04 | 2.630E+05 | 1.99 |
| PLA 6252 | 9.364E+04 | 5.314E+04 | 1.524E+05 | 1.76 |

The melt viscosity of PLAs was reduced to the desired level in 30 minutes, at a much faster rate than the Example 1 when citric acid is replaced with oxalic acid.

### Example 3

### Preparation of PLA Hot Melt Adhesive Composition 162455-33-1

The PLA adhesive was prepared similarly as previous examples except using 69 g of PLA 6252, 137 g of PLA 4060, 46 g of Hallgreen R8010, 22 g of SGP9300D (from Segetis) and 19 g of each citric acid. After the melt viscosity reached about 600 cps, another 69 g of PLA 6252D was added and dissolved at 190° C. to become the final product mixture. The melt viscosity and the molecular weight were measured by rheometer and exclusion chromatography.

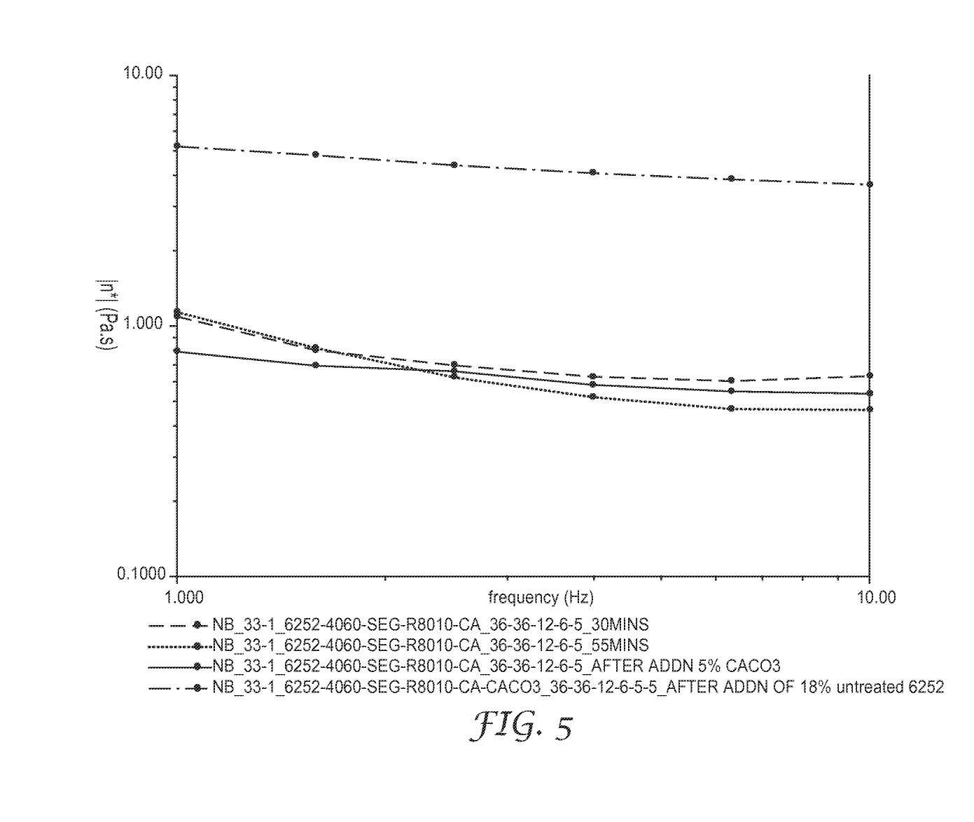

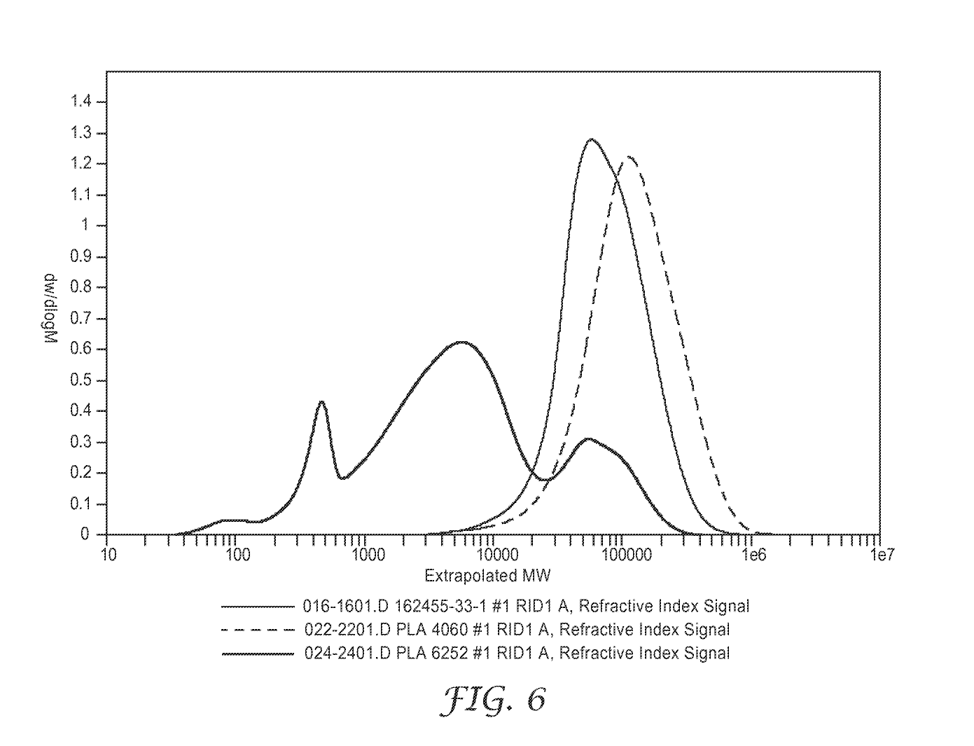

The results are represented by rheology FIG. 5 and molecular weight distribution FIG. 6. Also reported are the relative molecular weight and polydispersity values in Table 3.

TABLE 3

| Sample | | | | |
|---|---|---|---|---|
| Name | Mw | Mn | Mz | Polydispersity |
| 162455-33-1 | 1.996E+04 | 1.277E+03 | 8.645E+04 | 15.63 |
| PLA 4060 | 1.549E+05 | 7.785E+04 | 2.630E+05 | 1.99 |
| PLA 6252 | 9.364E+04 | 5.314E+04 | 1.524E+05 | 1.76 |

### Example 4

### Preparation of PLA Hot Melt Adhesive Composition 162455-115-1

A PLA adhesive composition was prepared using 296.4 g of PLA 6252, 76 g of SGP9300D (from Segetis) and 7.6 g of citric acid. To a 500 ml three-necked flask equipped with mechanical stirrer, thermometer, and condenser, 76 g of SGP9300D plasticizer (from Segetis) was charged and heated to 190° C. Then, 148.2 g of the PLA 6252 was slowly added; after the contents became solution, 3.8 g of the citric acid was slowly introduced and the mixture was allowed to react with agitation for 5 minutes. Then, the remaining 148.2 g of PLA 6252 was slowly added and allowed to mix. After the contents became solution, the remaining 3.8 g of citric acid was slowly introduced and the mixture was allowed to react with agitation for 1 hour. The melt viscosity and the molecular weight were measured by rheometer and size exclusion chromatography.

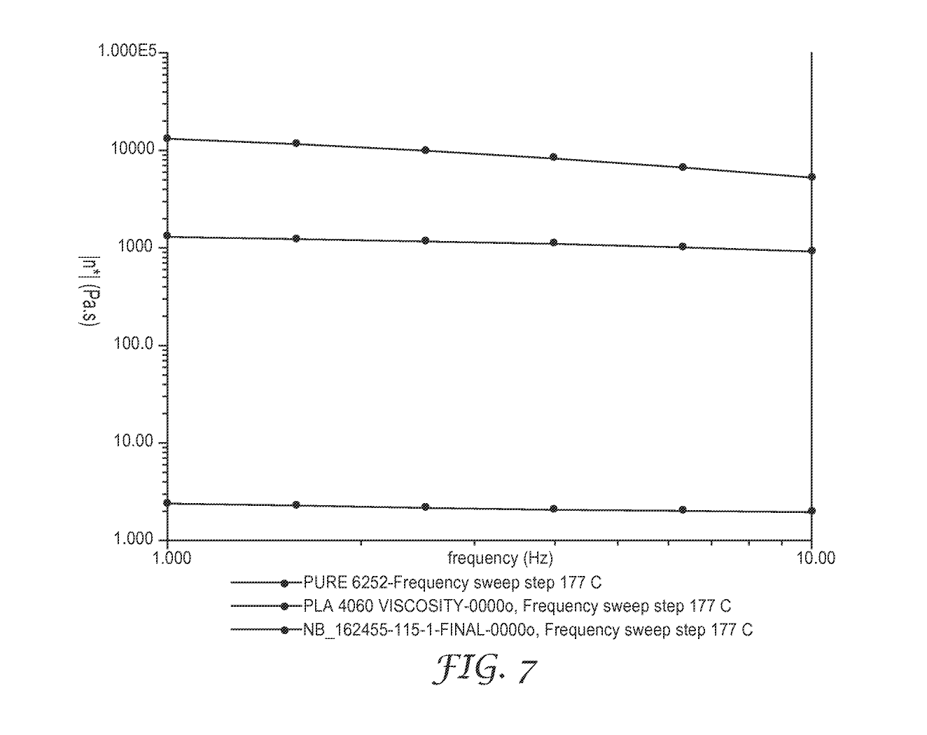

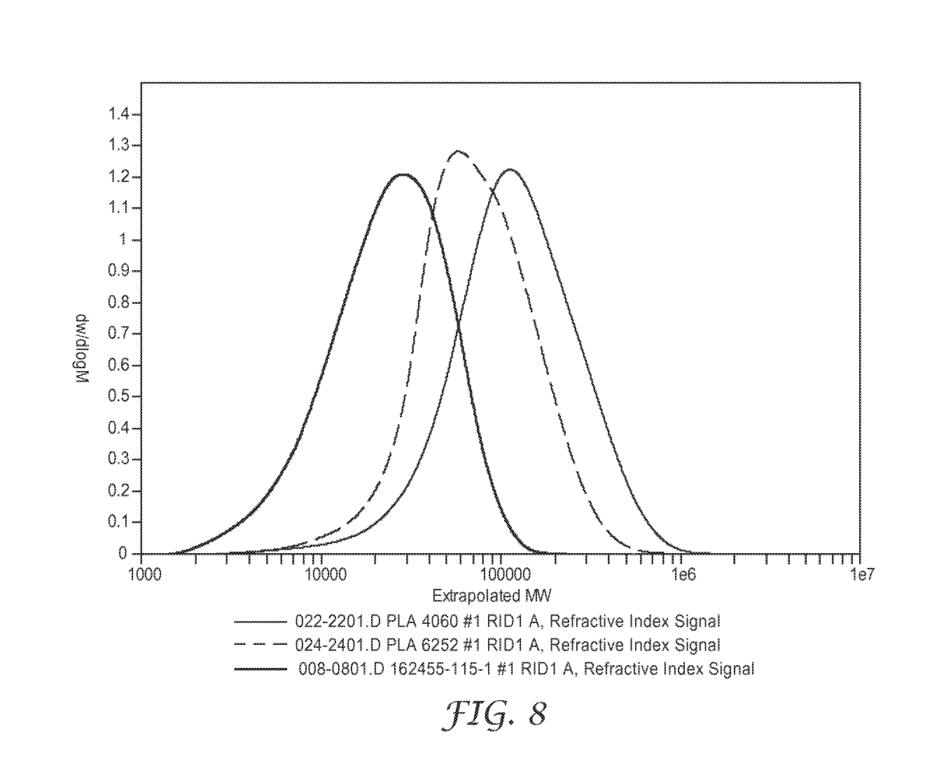

The results are represented by rheology FIG. 7 and molecular weight distribution FIG. 8. Also reported are the relative molecular weight and polydispersity values in Table 4.

TABLE 4

| | | | | Poly- |
|---|---|---|---|---|
| Sample Name | Mw | Mn | Mz | dispersity |
| 162455-115-1 | 3.026E+04 | 1.706E+04 | 4.557E+04 | 1.77 |
| PLA 4060 | 1.549E+05 | 7.785E+04 | 2.630E+05 | 1.99 |
| PLA 6252 | 9.364E+04 | 5.314E+04 | 1.524E+05 | 1.76 |

### Example 5

### Preparation of PLA Hot Melt Adhesive Composition 162455-116-1

A PLA adhesive composition was prepared using 296.4 g of PLA 6252, 76 g of SGP9300D (from Segetis) and 7.6 g of citric acid. To a 500 ml three-necked flask equipped with mechanical stirrer, thermometer, and condenser, 76 g of SGP9300D plasticizer (from Segetis) was charged and heated to 190° C. Then, 148.2 g of the PLA 6252 was slowly added; after the contents became solution, all of the 7.6 g of citric acid was slowly introduced and the mixture allowed to react with agitation for 1 hour. Then, the remaining 148.2 g of PLA 6252 was slowly added, allowed to mix and become solution. The heat was removed, ending the experiment. Samples were collected and the melt viscosity and molecular weight were measured by rheometer and size exclusion chromatography.

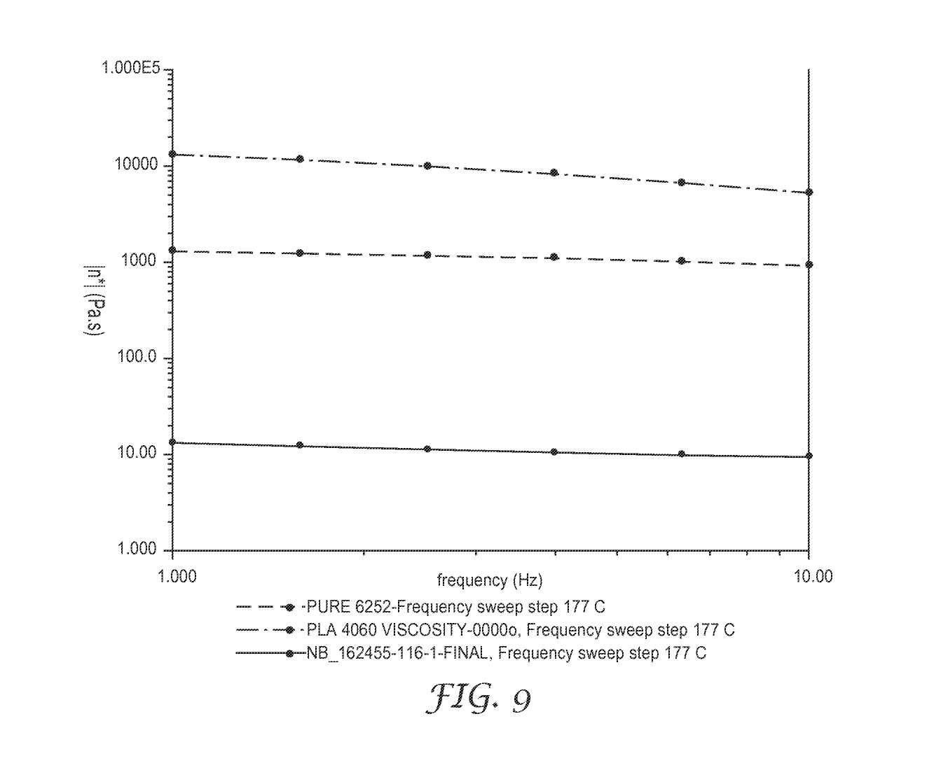

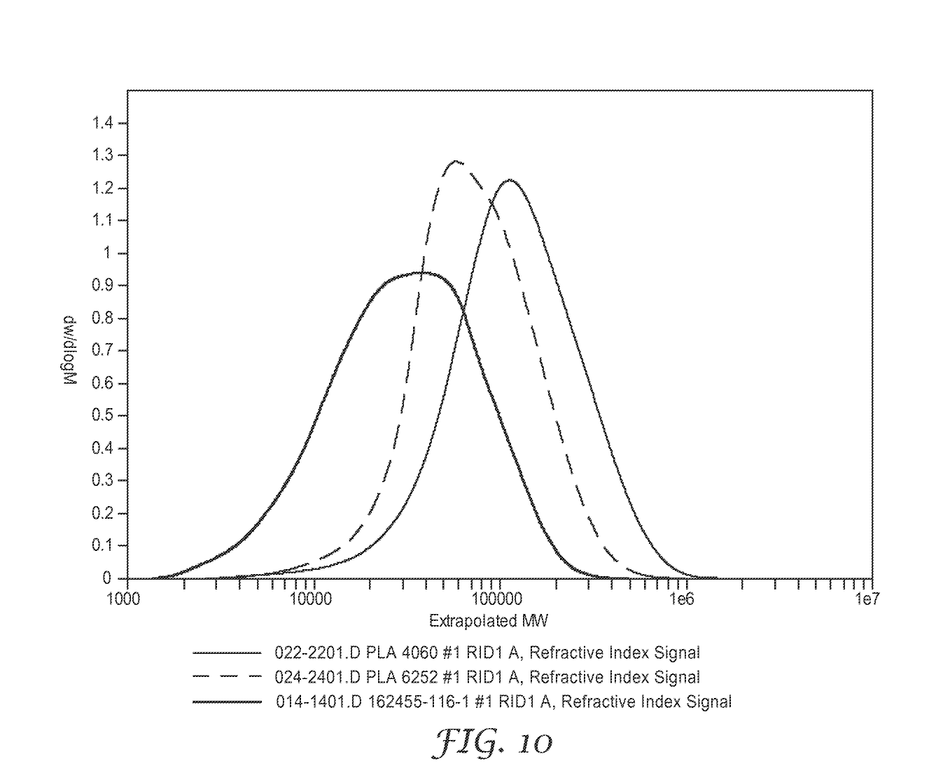

The results are represented by rheology FIG. 9 and molecular weight distribution FIG. 10. Also reported are the relative molecular weight and polydispersity values in Table 5.

TABLE 5

| | | | | Poly- |
|---|---|---|---|---|
| Sample Name | Mw | Mn | Mz | dispersity |
| 162455-116-1 | 4.363E+04 | 1.926E+04 | 7.969E+04 | 2.27 |
| PLA 4060 | 1.549E+05 | 7.785E+04 | 2.630E+05 | 1.99 |
| PLA 6252 | 9.364E+04 | 5.314E+04 | 1.524E+05 | 1.76 |

### Example 6

### Preparation of PLA Hot Melt Adhesive Composition 162455-116-2

A PLA adhesive composition was prepared using 296.4 g of PLA 6252, 76 g of SGP9300D (from Segetis) and 7.6 g of citric acid. To a 500 ml three-necked flask equipped with mechanical stirrer, thermometer, and condenser, 76 g of SGP9300D plasticizer (from Segetis) was charged and heated to 190° C. Then, 222.3 g of the PLA 6252 was slowly added; after the contents became solution, all of the 7.6 g of citric acid was slowly introduced and the mixture was allowed to react with agitation for 1 hour. Then, the remaining 74.1 g of PLA 6252 was slowly added, allowed to mix and become solution. The heat was then removed, ending the experiment. Samples were collected and the melt viscosity and molecular weight were measured by rheometer and size exclusion chromatography.

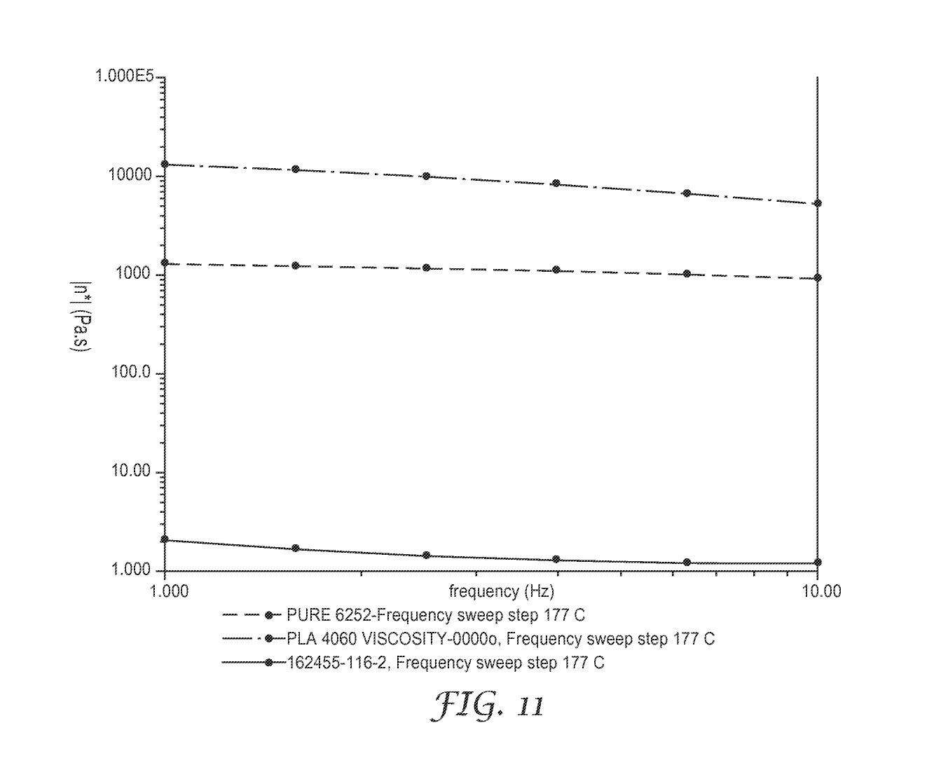

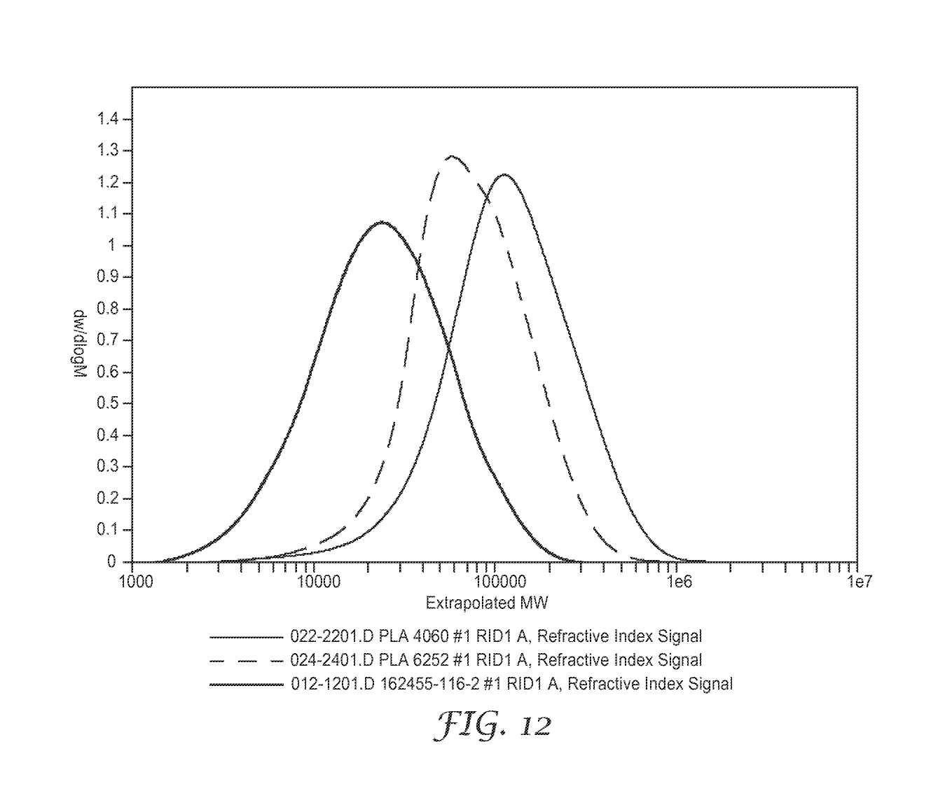

The results are represented by rheology FIG. 11 and molecular weight distribution FIG. 12. Also reported are the relative molecular weight and polydispersity values in Table 6.

TABLE 6

| | | | | Poly- |
|---|---|---|---|---|
| Sample Name | Mw | Mn | Mz | dispersity |
| 162455-116-2 | 3.320E+04 | 1.587E+04 | 6.222E+04 | 2.09 |
| PLA 4060 | 1.549E+05 | 7.785E+04 | 2.630E+05 | 1.99 |
| PLA 6252 | 9.364E+04 | 5.314E+04 | 1.524E+05 | 1.76 |

### Example 7

### Preparation of PLA Hot Melt Adhesive Composition 165161-7-1

A PLA adhesive composition was prepared using 311.6 g of PLA 6252, 57 g of SGP9300D (from Segetis) and 11.4 g of citric acid. To a 500 ml three-necked flask equipped with mechanical stirrer, thermometer, and condenser, 57 g of SGP9300D plasticizer (from Segetis) was charged and heated to 190 C. Then, 103.9 g of the PLA 6252 was slowly added; after the contents became solution, 3.8 g of citric acid was slowly introduced and the mixture was allowed to react with agitation for 5 min. Then, 103.9 g of the remaining PLA 6252 was slowly added; after the contents became solution, 3.8 g of citric acid was slowly introduced and the mixture allowed to react with agitation for 5 min. The remaining 103.9 g of the PLA 6252 was slowly added; after the contents became a solution, the remaining 3.8 g of citric acid was slowly introduced and the mixture was allowed to react with agitation for 1 hour. The heat was then removed, ending the experiment. Samples were collected and the melt viscosity and molecular weight were measured by rheometer and size exclusion chromatography.

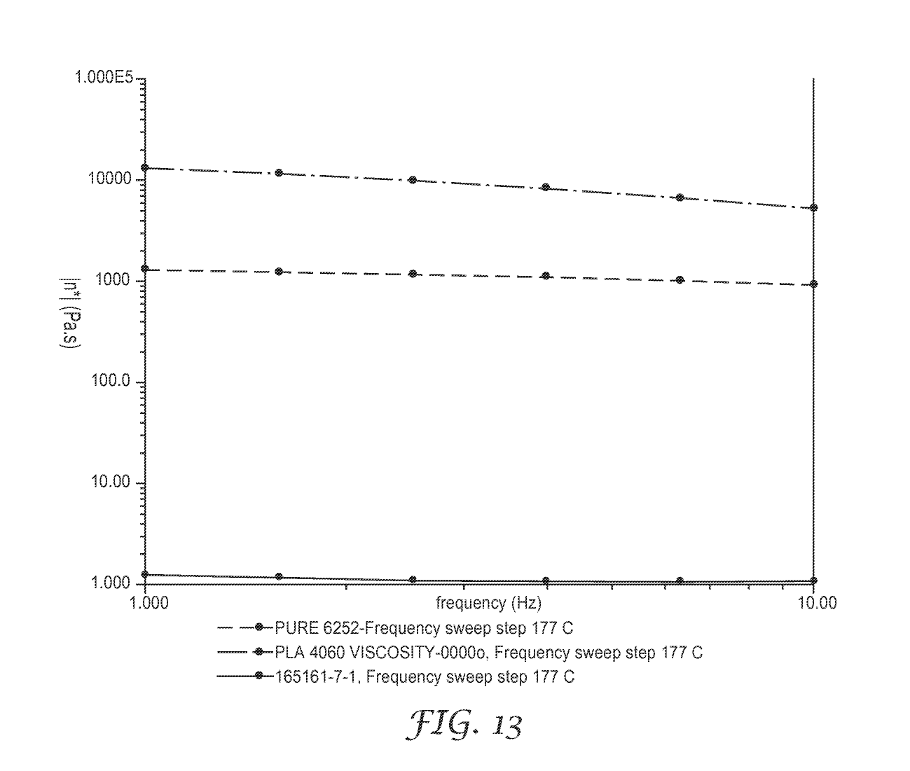

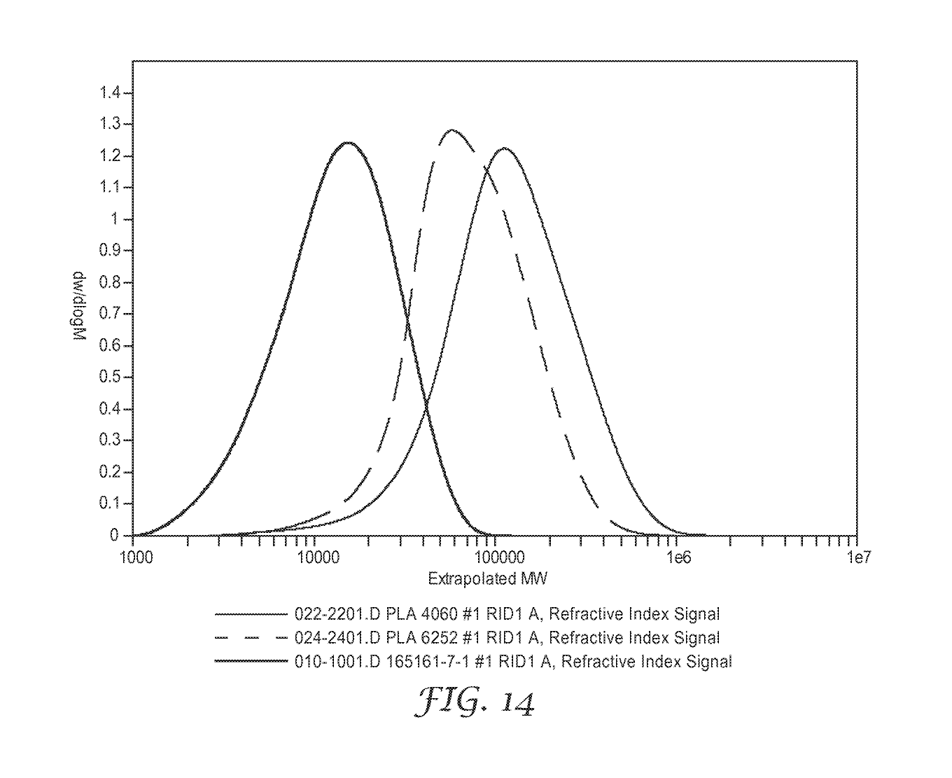

The results are represented by rheology FIG. 13 and molecular weight distribution FIG. 14. Also reported are the relative molecular weight and polydispersity values in Table 7.

TABLE 7

| | | | | Poly- |
|---|---|---|---|---|
| Sample Name | Mw | Mn | Mz | dispersity |
| 165161-7-1 | 1.701E+04 | 9.860E+03 | 2.569E+04 | 1.73 |
| PLA 4060 | 1.549E+05 | 7.785E+04 | 2.630E+05 | 1.99 |
| PLA 6252 | 9.364E+04 | 5.314E+04 | 1.524E+05 | 1.76 |

### Example 8

### Preparation of PLA Hot Melt Adhesive Composition 165161-10-1

A PLA adhesive composition was prepared using 315.4 g of PLA 4060, 57 g of SGP9300D (from Segetis) and 7.6 g of citric acid. To a 500 ml three-necked flask equipped with mechanical stirrer, thermometer, and condenser, 57 g of SGP9300D plasticizer (from Segetis) was charged and heated to 190 C. Then, 78.85 g of the PLA 4060 was slowly added; after the contents became solution, 1.9 g of citric acid was slowly introduced and the mixture was allowed to react with agitation for 5 mins. Then, 78.85 g of the remaining PLA 4060 was slowly added; after the contents became solution, 1.9 g of citric acid was slowly introduced and again the mixture was allowed to react with agitation for 5 mins Then, 78.85 g of the remaining PLA 4060 was slowly added; after the contents became solution, 1.9 g of citric acid was slowly introduced and the mixture again was allowed to react with agitation for 5 mins The remaining 78.85 g of the PLA 4060 was slowly added; after the contents became solution, the remaining 1.9 g of citric acid was slowly introduced and the mixture was allowed to react with agitation for 1 hour. The heat was then removed, ending the experiment. Samples were collected and the melt viscosity and molecular weight were measured by rheometer and size exclusion chromatography.

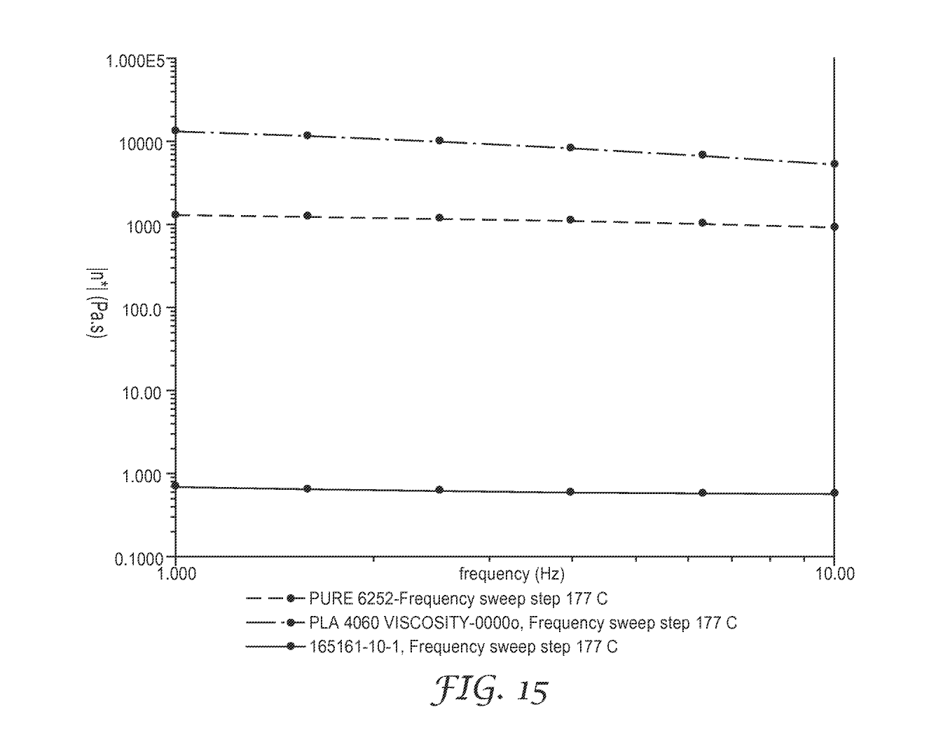

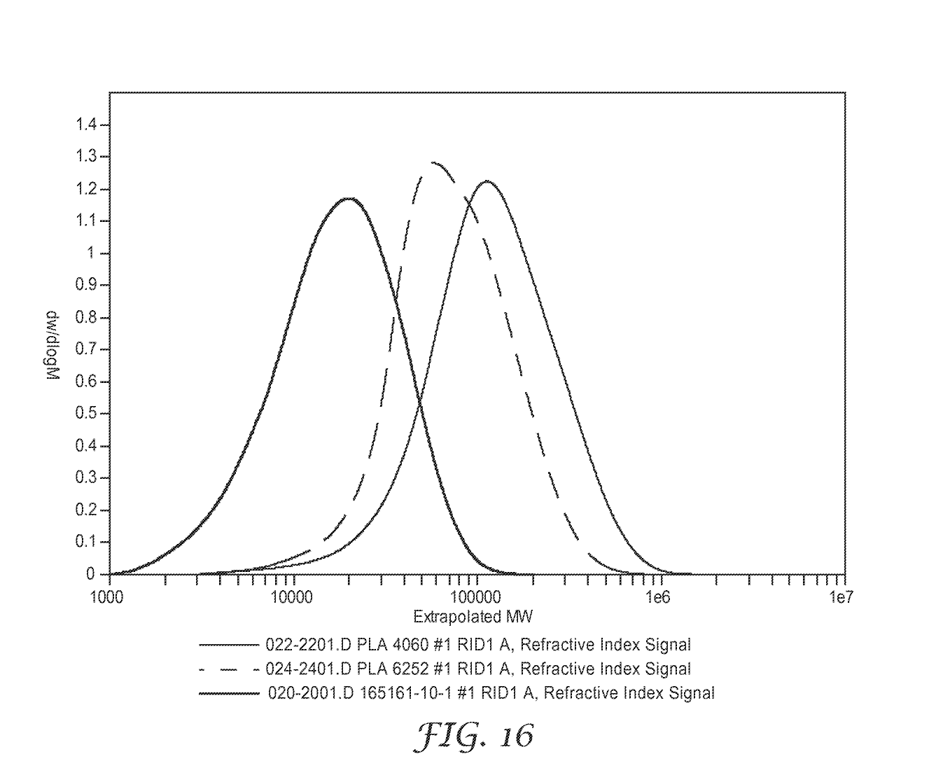

The results are represented by rheology FIG. 15 and molecular weight distribution FIG. 16. Also reported are the relative molecular weight and polydispersity values in Table 8.

TABLE 8

| | | | | Poly- |
|---|---|---|---|---|
| Sample Name | Mw | Mn | Mz | dispersity |
| 165161-10-1 | 2.210E+04 | 1.197E+04 | 3.492E+04 | 1.85 |
| PLA 4060 | 1.549E+05 | 7.785E+04 | 2.630E+05 | 1.99 |
| PLA 6252 | 9.364E+04 | 5.314E+04 | 1.524E+05 | 1.76 |

### Example 9

### Preparation of PLA Hot Melt Adhesive Composition 165161-22-1

A PLA adhesive composition was prepared using 302.1 g of PLA 6252, 76 g of SGP9300D (from Segetis) and 1.9 g of Sodium Hydroxide (NaOH). To a 500 ml three-necked flask equipped with mechanical stirrer, thermometer, and condenser, 76 g of SGP9300D plasticizer (from Segetis) was charged and heated to 190° C. Then, 151.05 g of the PLA 6252 was slowly added; after the contents became solution, 0.95 g of sodium hydroxide was slowly introduced and the mixture was allowed to react with agitation for about 10 mins The remaining 151.05 g of the PLA 6252 was slowly added; after the contents became solution, the remaining 0.95 g of sodium hydroxide was slowly introduced and the mixture was allowed to react with agitation for 1 hour. The heat was removed, ending the experiment. Samples were collected and the melt viscosity and molecular weight were measured by rheometer and size exclusion chromatography respectively.

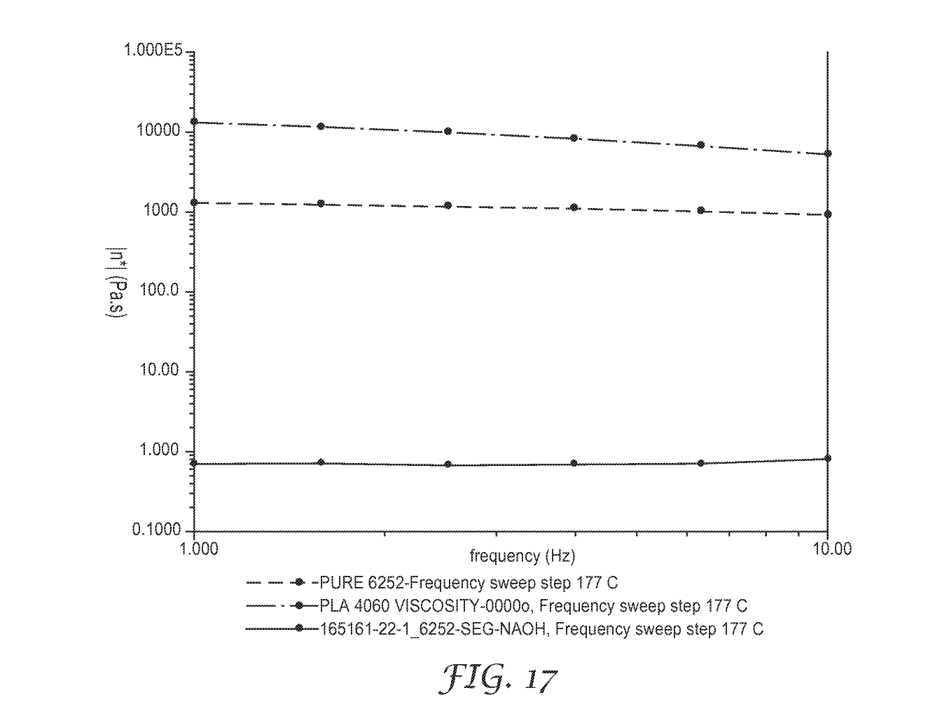

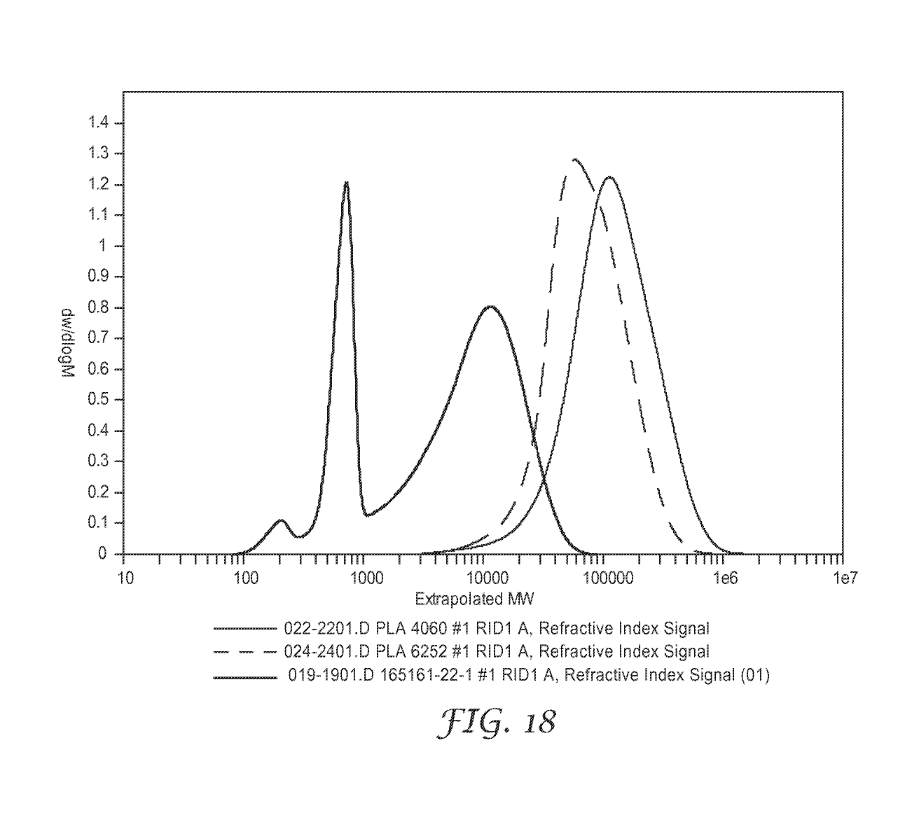

The results are represented by rheology FIG. 17 and molecular weight distribution FIG. 18. Also reported are the relative molecular weight and polydispersity values in Table 9.

TABLE 9

| | | | | Poly- |
|---|---|---|---|---|
| Sample Name | Mw | Mn | Mz | dispersity |
| 165161-22-1 | 8.612E+03 | 1.443E+03 | 1.892E+04 | 5.97 |
| PLA 4060 | 1.549E+05 | 7.785E+04 | 2.630E+05 | 1.99 |
| PLA 6252 | 9.364E+04 | 5.314E+04 | 1.524E+05 | 1.76 |

### Example 10

### Preparation of PLA Hot Melt Adhesive Composition 165161-21-2

A PLA adhesive composition was prepared using 285 g of PLA 6252, 76 g of SGP9300D (from Segetis) and 19 g of undecan-1-ol. To a 500 ml three-necked flask equipped with mechanical stirrer, thermometer, and condenser, 76 g of SGP9300D plasticizer (from Segetis) was charged and heated to 190° C. Then, 142.5 g of the PLA 6252 was slowly added; after the contents became solution, all the 19 g of undecan-1-ol was slowly introduced and the mixture was allowed to react with agitation for 1-hr. The heat was removed, ending the experiment. Samples were collected and the melt viscosity and molecular weight were measured by rheometer and size exclusion chromatography respectively.

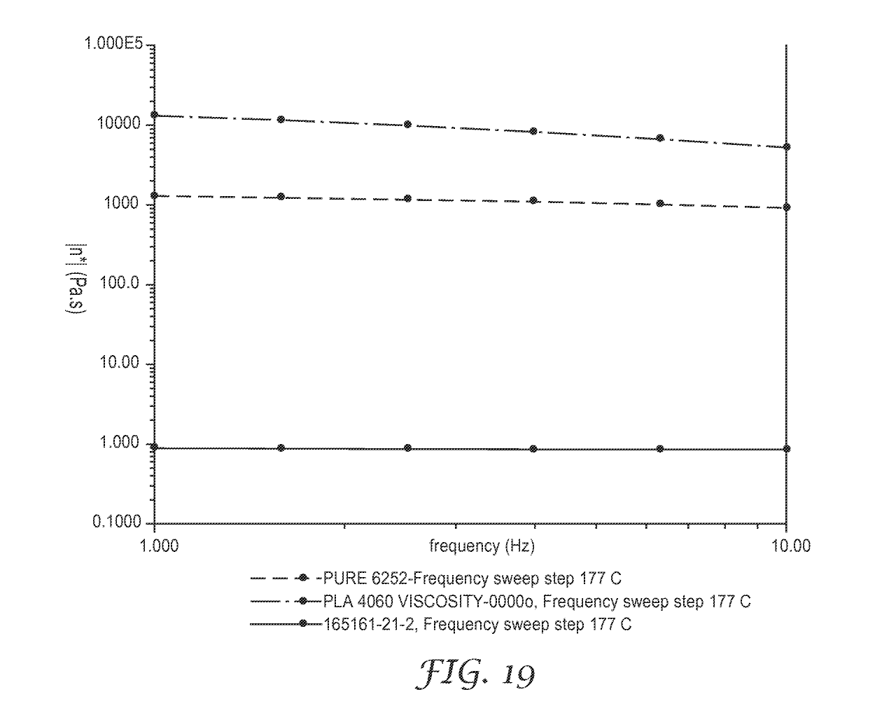

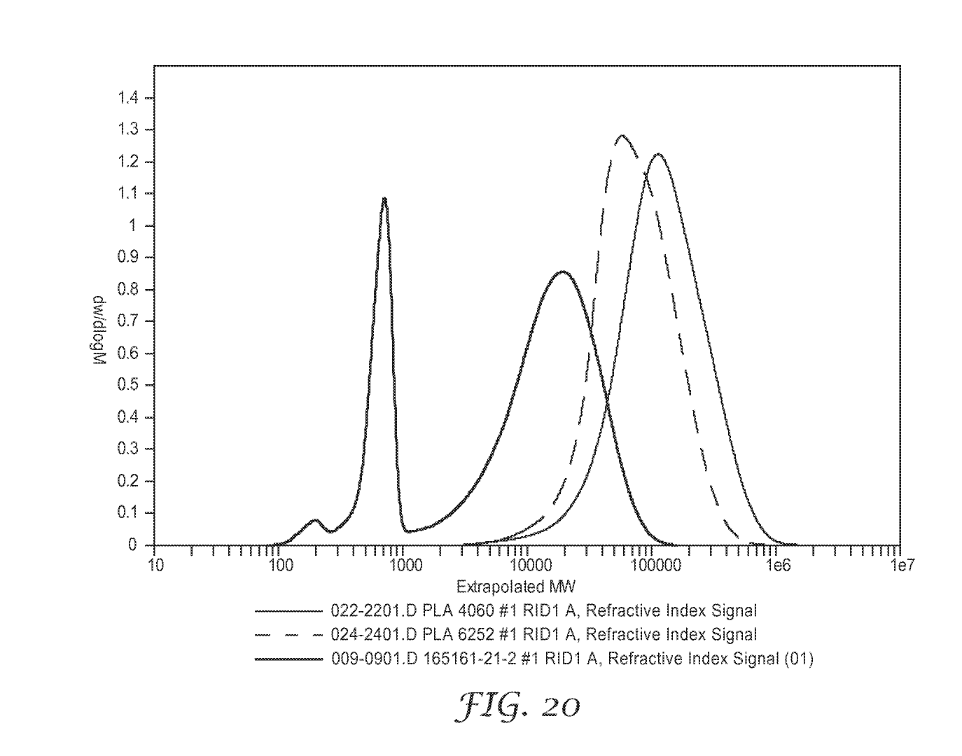

The results are represented by rheology (FIG. 19) and molecular weight distribution (FIG. 20). Also reported are the relative molecular weight and polydispersity values in Table 10.

TABLE 10

| | | | | Poly- |
|---|---|---|---|---|
| Sample Name | Mw | Mn | Mz | dispersity |
| 165161-21-2 | 1.604E+04 | 1.816E+03 | 3.398E+04 | 8.84 |
| PLA 4060 | 1.549E+05 | 7.785E+04 | 2.630E+05 | 1.99 |
| PLA 6252 | 9.364E+04 | 5.314E+04 | 1.524E+05 | 1.76 |

### Example 11

### Preparation of PLA Hot Melt Adhesive Composition 165161-18-1

A PLA adhesive composition was prepared using 296.4 g of PLA 6252, 76 g of SGP9300D (from Segetis) and 7.6 g of undecanoic acid. To a 500 ml three-necked flask equipped with mechanical stirrer, thermometer, and condenser, 76 g of SGP9300D plasticizer (from Segetis) was charged and heated to 190° C. Then, 148.2 g of the PLA 6252 was slowly added; after the contents became solution, 3.8 g of undecanoic acid was slowly introduced and the mixture was allowed to react with agitation for about 10 mins. The remaining 148.2 g of the PLA 6252 was slowly added; after the contents became a solution, the remaining 3.8 g of undecanoic acid was slowly introduced and the mixture was allowed to react with agitation for about 1 hr. The heat was then removed, ending the experiment. Samples were collected and the melt viscosity and molecular weight were measured by rheometer and size exclusion chromatography respectively.

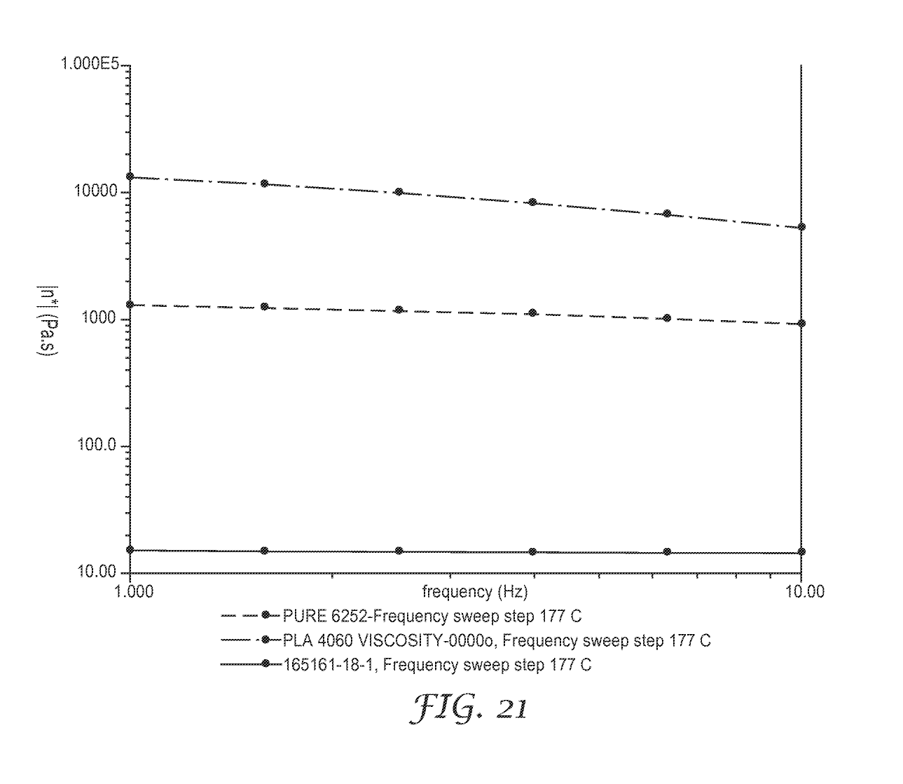

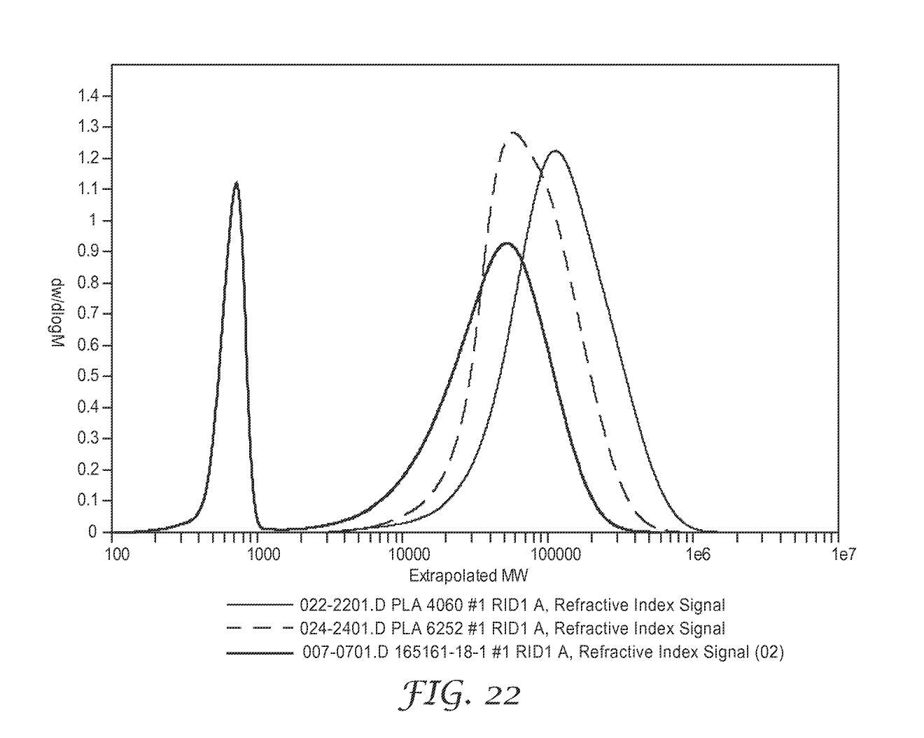

The results are represented by rheology FIG. 21 and molecular weight distribution FIG. 22. Also reported are the relative molecular weight and polydispersity values in Table 11.

TABLE 11

| | | | | Poly- |
|---|---|---|---|---|
| Sample Name | Mw | Mn | Mz | dispersity |
| 165161-18-1 | 4.391E+04 | 2.547E+03 | 9.151E+04 | 17.24 |
| PLA 4060 | 1.549E+05 | 7.785E+04 | 2.630E+05 | 1.99 |
| PLA 6252 | 9.364E+04 | 5.314E+04 | 1.524E+05 | 1.76 |

### Example 12

### Preparation of PLA Hot Melt Adhesive Composition 165161-16-1

A PLA adhesive composition was prepared using 300.2 g of PLA 6252, 76 g of SGP9300D (from Segetis) and 3.8 g of p-toluenesulfonic acid. To a 500 ml three-necked flask equipped with mechanical stirrer, thermometer, and condenser, 76 g of SGP9300D plasticizer (from Segetis) was charged and heated to 190° C. Then, 150.1 g of the PLA 6252 was slowly added; after the contents became solution, 1.9 g of p-Toluenesulfonic acid was slowly introduced and the mixture was allowed to react with agitation for about 10 mins. The remaining 150.1 g of the PLA 6252 was slowly added; after the contents became solution, the remaining 1.9 g of p-Toluenesulfonic acid was slowly introduced and the mixture was allowed to react with agitation for about 1 hr. The heat was then removed, ending the experiment. Samples were collected and the melt viscosity and molecular weight were measured by rheometer and size exclusion chromatography respectively.

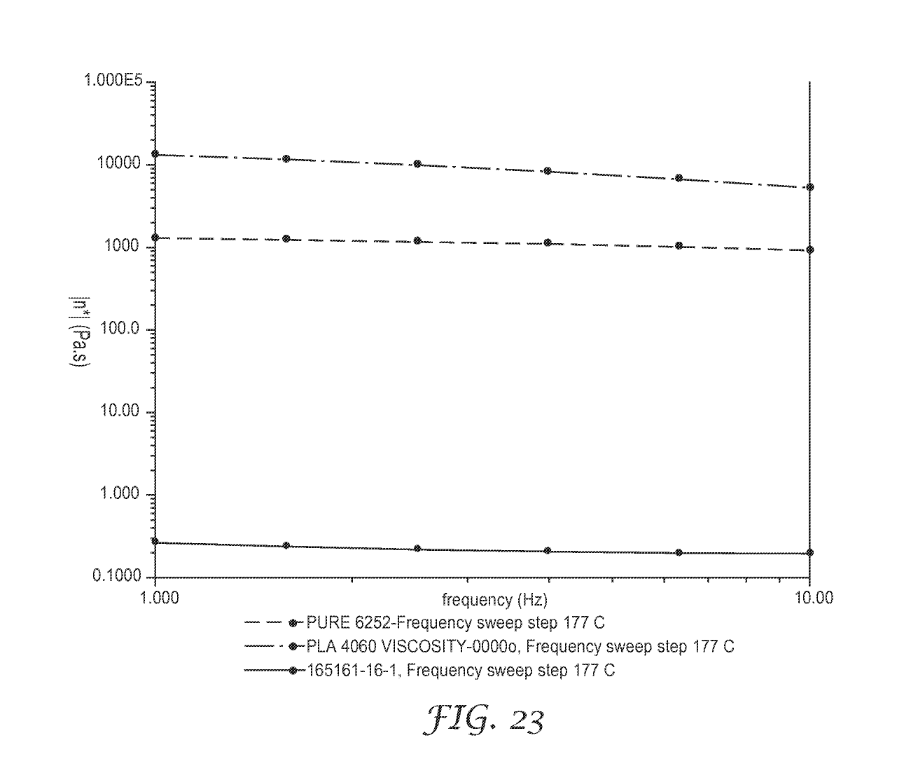

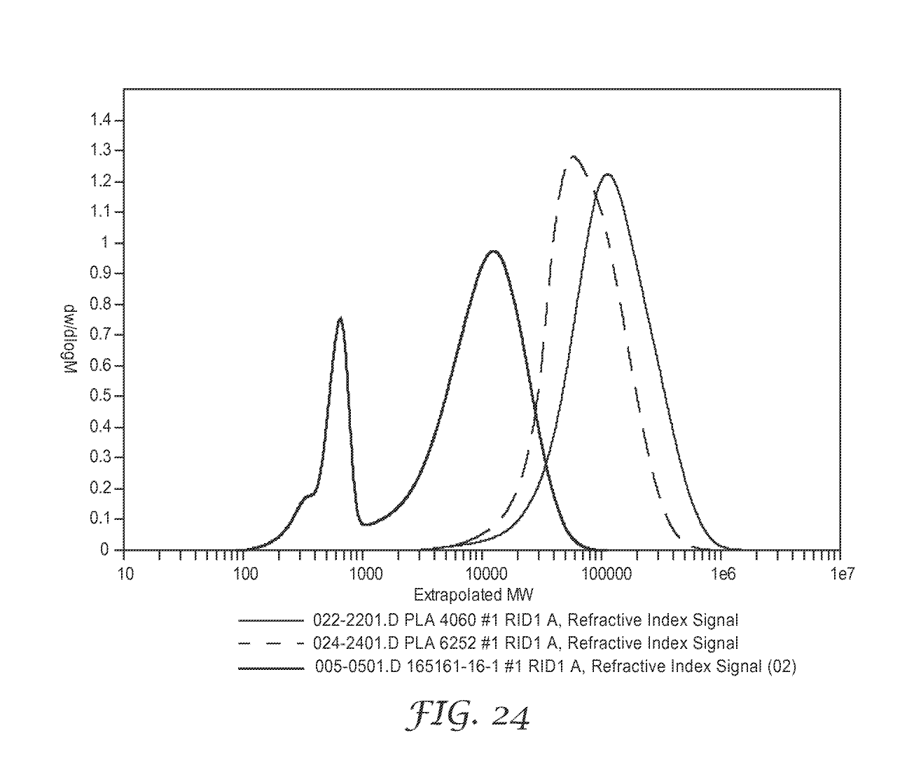

The results are represented by theology (FIG. 23) and molecular weight distribution (FIG. 24). Also reported are the relative molecular weight and polydispersity values in Table 12.

TABLE 12

| Sample | | | | |
|---|---|---|---|---|
| Name | Mw | Mn | Mz | Polydispersity |
| 165161-16-1 | 1.058E+04 | 1.854E+03 | 2.029E+04 | 5.71 |
| PLA 4060 | 1.549E+05 | 7.785E+04 | 2.630E+05 | 1.99 |
| PLA 6252 | 9.364E+04 | 5.314E+04 | 1.524E+05 | 1.76 |

### Example 13

### Preparation of PLA Hot Melt Adhesive Composition 165161-28-1

A PLA adhesive composition was prepared using 282.7 g of PLA 6252, 76 g of SGP9300D (from Segetis) and 15.2 g of stearic acid. To a 500 ml three-necked flask equipped with mechanical stirrer, thermometer, and condenser, 76 g of SGP9300D plasticizer (from Segetis) was charged and heated to 190° C. Then, 141.35 g of the PLA 6252 was slowly added; after the contents became solution, 7.6 g of stearic acid was slowly introduced and the mixture was allowed to react with agitation for about 10 mins The remaining 141.35 g of the PLA 6252 was slowly added; after the contents became solution, the remaining 7.6 g of stearic acid was slowly introduced and the mixture was allowed to react with agitation for about 4 hr. The heat was then removed, ending the experiment. Samples were collected and the melt viscosity and molecular weight were measured by rheometer and size exclusion chromatography respectively.

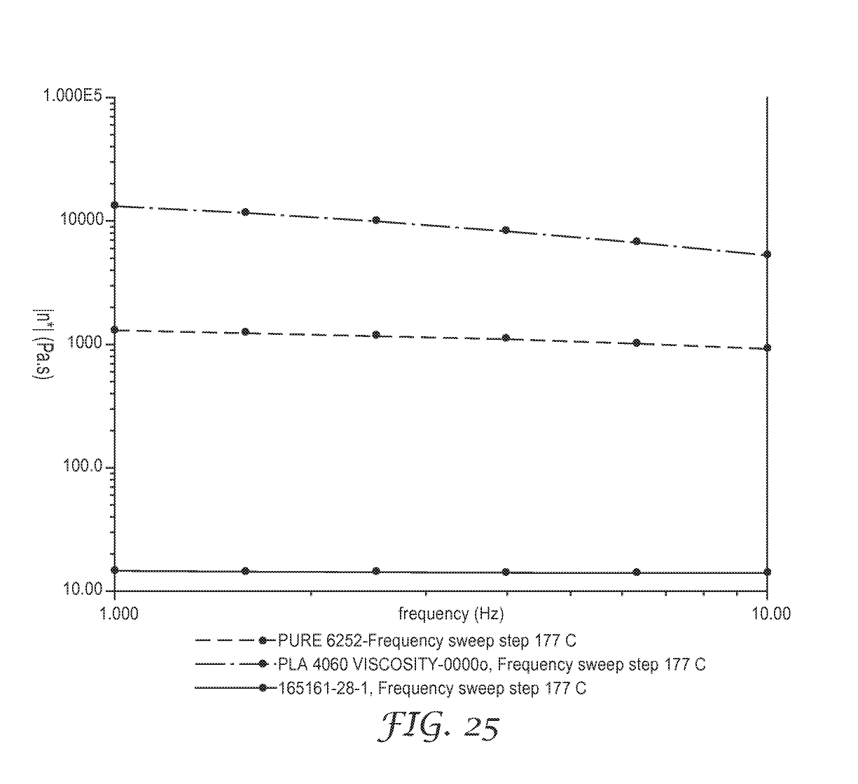

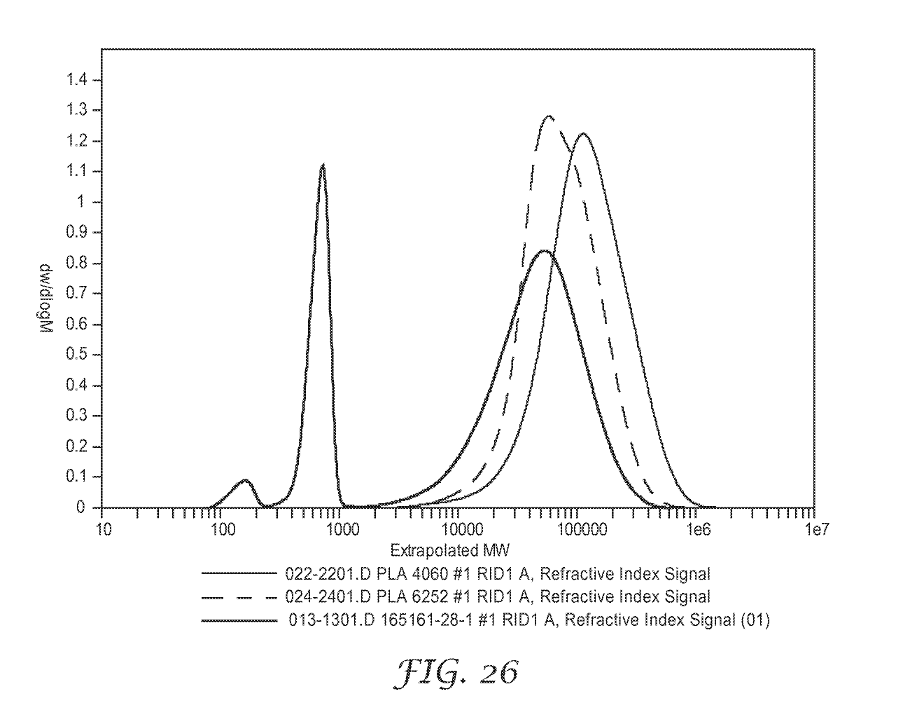

The results are represented by rheology (FIG. 25) and molecular weight distribution (FIG. 26). Also reported are the relative molecular weight and polydispersity values in Table 13.

TABLE 13

| Sample | | | | |
|---|---|---|---|---|
| Name | Mw | Mn | Mz | Polydispersity |
| 165161-28-1 | 4.856E+04 | 1.871E+03 | 1.130E+05 | 25.98 |
| PLA 4060 | 1.549E+05 | 7.785E+04 | 2.630E+05 | 1.99 |
| PLA 6252 | 9.364E+04 | 5.314E+04 | 1.524E+05 | 1.76 |

### Example 14

### Preparation of PLA Hot Melt Adhesive Composition 165161-28-2

A PLA adhesive composition was prepared using 296.4 g of PLA 6252, 76 g of SGP9300D (from Segetis) and 7.6 g of diethanolamine. To a 500 ml three-necked flask equipped with mechanical stirrer, thermometer, and condenser, 76 g of SGP9300D plasticizer (from Segetis) was charged and heated to 190° C. Then, 148.2 g of the PLA 6252 was slowly added; after the contents became solution, 3.8 g of diethanolamine was slowly introduced and the mixture was allowed to react with agitation for about 10 mins. The remaining 148.2 g of the PLA 6252 was slowly added; after the contents became a solution, the remaining 3.8 g of diethanolamine was slowly introduced and the mixture was allowed to react with agitation for about 10 mins The heat was then removed, ending the experiment. Samples were collected and the melt viscosity and molecular weight were measured by rheometer and size exclusion chromatography respectively.

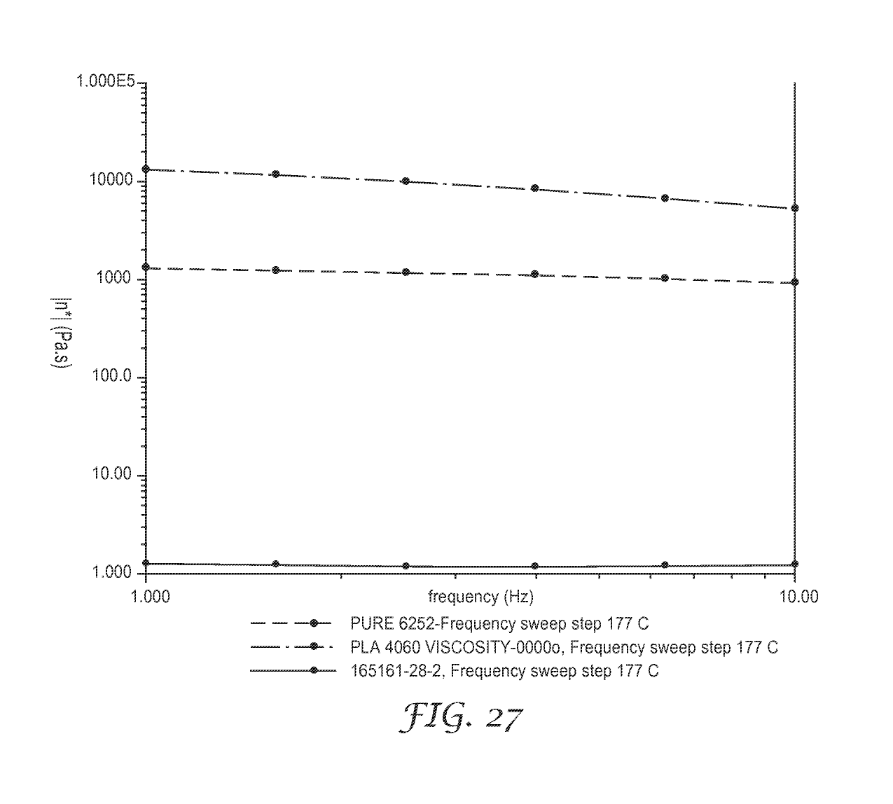

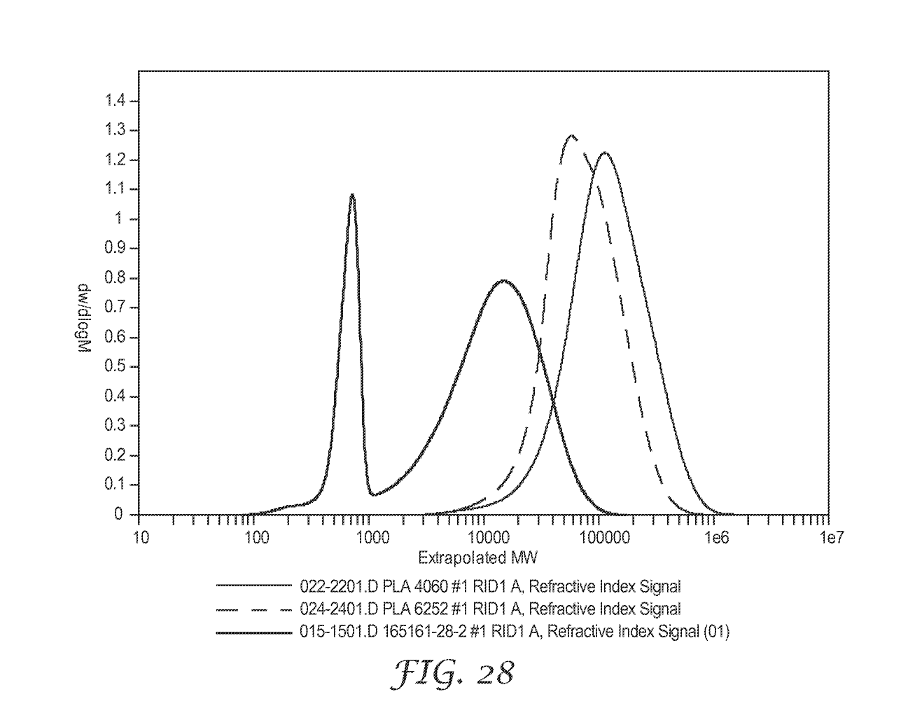

The results are represented by rheology (FIG. 27) and molecular weight distribution (FIG. 28). Also reported are the relative molecular weight and polydispersity values in Table 14.

TABLE 14

| Sample | | | | |
|---|---|---|---|---|
| Name | Mw | Mn | Mz | Polydispersity |
| 165161-28-2 | 1.359E+04 | 1.978E+03 | 3.070E+04 | 6.87 |
| PLA 4060 | 1.549E+05 | 7.785E+04 | 2.630E+05 | 1.99 |
| PLA 6252 | 9.364E+04 | 5.314E+04 | 1.524E+05 | 1.76 |

### Rheological Analysis for Hot Tack

The following samples were analyzed for hot tack using the rheometer model AR-G2: (1) HMA Composition from Example 2; (2) HMA Composition from Example 1; (3) Ethylene Vinyl Acetate hot melt adhesive available from 3M, St. Paul, Minn., under the trade designation Scotch Weld 3762 LM; (4) Ethylene Vinyl Acetate hot melt adhesive available from 3M under the trade designation Scotch Weld 3762 (available from 3M, St. Paul, Minn.); (5) PLA 6252 crystalline grade; and (6) PLA 4060 amorphous grade.

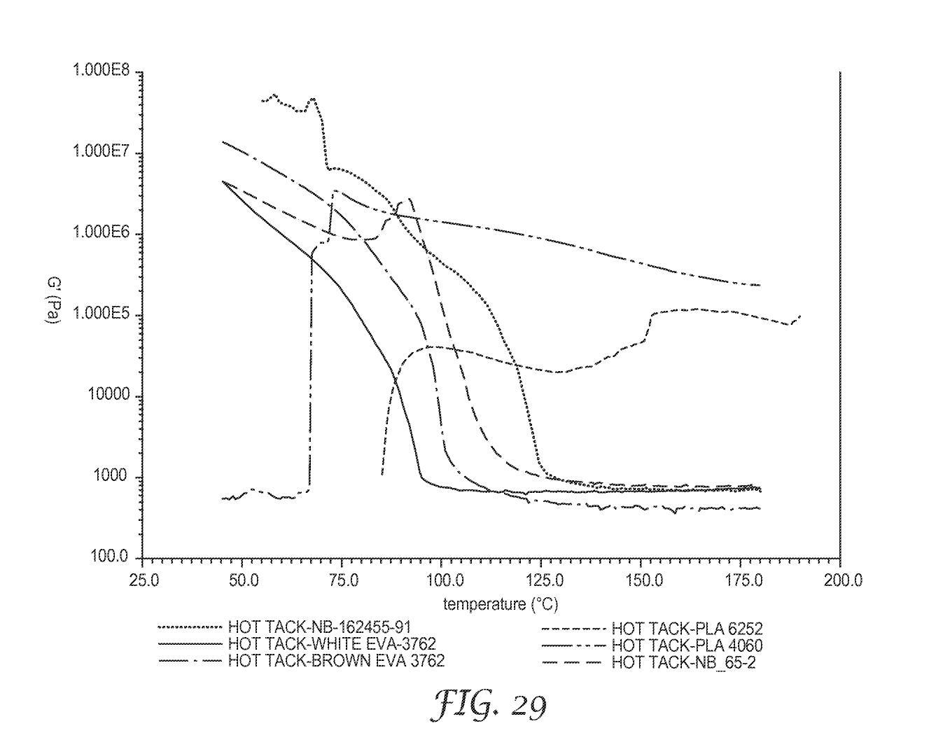

Using the AR-G2 rheometer, each sample was held between two plates of the rheometer: an 8mm spindle and a heated hot plate that measured 80mm at a gap of 650 microns. The samples were then each simultaneously subjected to a sinusoidal strain of 5% while the temperature was ramped from 180° C. to 45° C. at a rate of 5° C. a minute. The instrument then collected data of the elastic modulus (G′) in Pa at intervals of 10 sec. These data are shown in FIG. 29.

As shown in FIG. 29, moving from high temperature to low temperature captures how the polymeric sample builds bond strength as it cools to room temperature. At high temperatures it is necessary for the sample to have a low modulus so it can adequately wet the substrate to which it is applied. As the applied hot melt sample cools, it begins to build modulus which translates to a build in bond strength with the substrate. At a specific relatively narrow temperature range along the cool down phase there is a marked build in modulus representing a significant build in bond strength. This zone is referred to as the hot tack zone. The higher the temperature at which this hot tack zone occurs the quicker the sample is in building bond strength with the substrate.

From FIG. 29 the samples from Example 2 and Example 1 exhibit the highest onset of the hot tack zone which correlates to a faster build in bond strength. The samples PLA 4060 and PLA 6252, because of their high modulus, even at high temperatures never achieve adequate wetting of the substrate and as such never build adherence to the substrate, limiting their function as an effective hot melt adhesive.

### Example 15

### Preparation of Hot Melt Adhesive Composition 165161-72-1

A Type Six melt mixer with CAM blade from Brabender Instruments, Inc., South Hackensack, N.J., was used. The melt mixer was heated to 180° C. and the CAM blades set to mix at a rate of 65 rpm. 44.4 g of PLA 4060 pellets were slowly added to the mixing bowl with CAM blades rotating ensuring all the polymer was melted and well mixed before moving to the next step. Then, 0.6 g of triethanolamine, reagent grade, obtained from J.T. Baker, Phillipsburg, N.J., was slowly added via a plastic 3 ml dropper—a few drops every 5 secs. After the contents were visually well mixed, 9.0 g of CARBOWAX SENTRY Polyethylene Glycol-8000 powder, obtained from Dow Chemical Co., Midland, Mich., was slowly added until it completely dissolved and was well mixed into the molten polymer. Lastly, 6.0 g of Hallgreen R-8010 was slowly added to the polymer melt until it completely dissolved into the mix. The mixture was then drained from the mixing bowl into an aluminum tray for analysis.

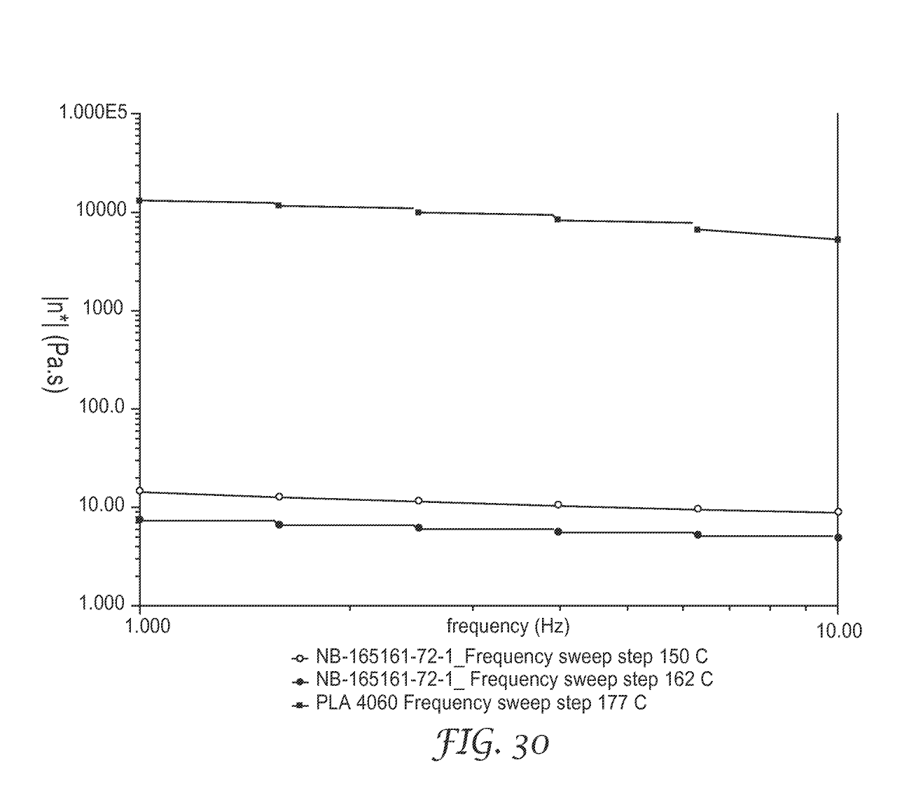

The resulting polymer was evaluated for hot melt adhesive application. The melt viscosity was measured by a rheometer model AR-G2 from TA instruments (New Castle, Del.) and results are summarized in FIG. 30.

### Example 16

### Preparation of PLA Hot Melt Adhesive Composition 165161-72-2

A Type Six melt mixer with CAM blade from Brabender was heated to 180° C. and the CAM blades set to mix at a rate of 65 rpm. 41.4 g of PLA 4060 pellets were slowly added to the mixing bowl with CAM blades rotating ensuring all polymer was melted and well mixed before moving to the next step. Then, 0.6 g of Triethanolamine, reagent grade, obtained from J.T. Baker, was slowly added via a plastic 3 ml dropper—a few drops every 5 sec. After the contents were visually well mixed, 6.0 g of CARBOWAX SENTRY Polyethylene Glycol-8000 powder was slowly added until it completely dissolved and was well mixed into the molten polymer. Then, 3.0 g of liquid epoxy resin, EPON 828, obtained from Momentive, Columbus, Ohio, was added until it blended completely into the melt. Lastly, 9.0 g of Hallgreen R-8010 was slowly added to the polymer melt until it completely dissolved into the mix. The mixture was then drained from the mixing bowl into an aluminum tray for analysis.

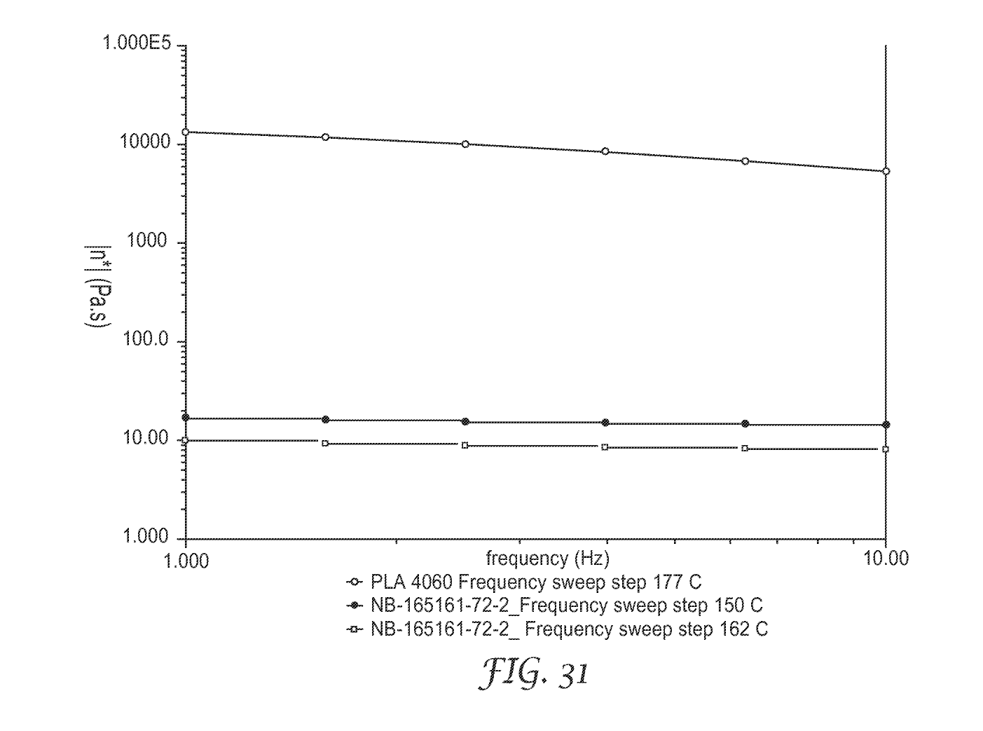

The resulting polymer was evaluated for use as a hot melt adhesive. The melt viscosity was measured by a rheometer model AR-G2 from TA instruments, and results are summarized in FIG. 31.

### Example 17

### Preparation of PLA Hot Melt Adhesive Composition 165161-72-3

A Type Six melt mixer with CAM blade from Brabender was heated to 180° C. and the CAM blades set to mix at a rate of 65 rpm. 41.4 g of PLA 4060 pellets were slowly added to the mixing bowl with CAM blades rotating ensuring all polymer was melted and well mixed before moving to the next step. Then, 0.6 g of Triethanolamine, reagent grade, obtained from J.T. Baker, was slowly added via a plastic 3 ml dropper—a few drops every 5 sec. After the contents were visually well mixed, 3.0 g of CARBOWAX SENTRY Polyethylene Glycol-8000 powder was slowly added until it completely dissolved and was well mixed into the molten polymer. Then, 3.0 g of liquid epoxy resin, EPON 828, obtained from Momentive, Columbus, Ohio, was added until it blended completely into the melt. Furthermore, 3.0 g of solid epoxy resin, EPON 2004, also obtained from Momentive, was added until it blended completely into the melt. Lastly, 9.0 g of Hallgreen R-8010 was slowly added to the polymer melt until it completely dissolved into the mix. The mixture was then drained from the mixing bowl into an aluminum tray for analysis.

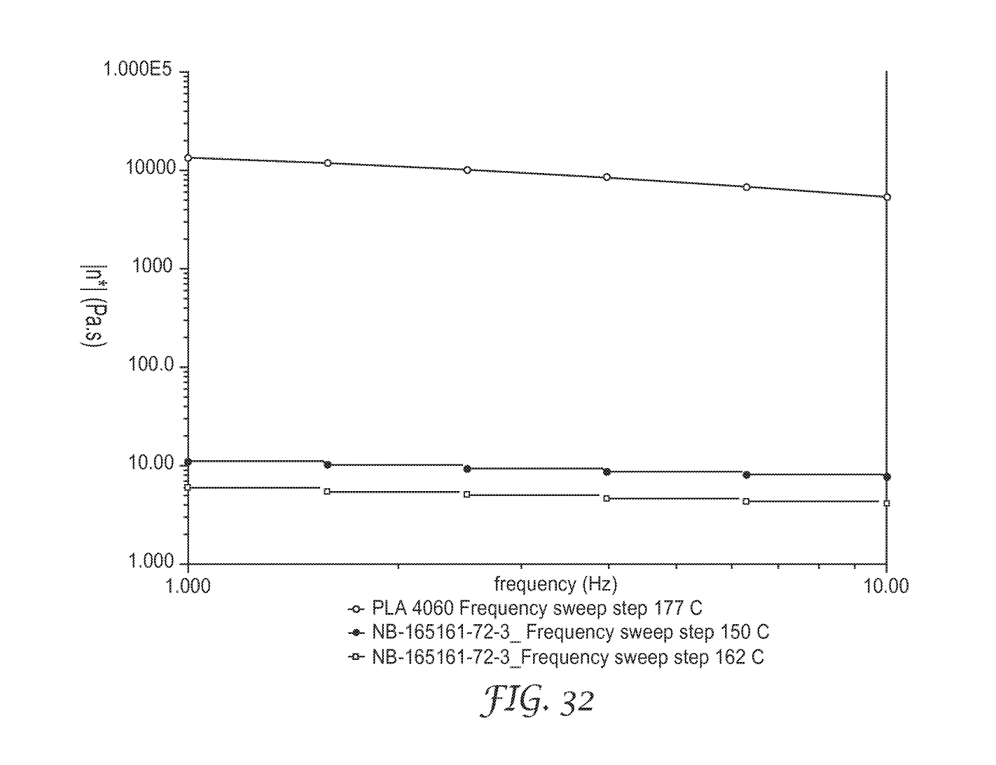

The resulting polymer was evaluated for use in hot melt adhesive applications. The melt viscosity was measured by a rheometer model AR-G2 and results are summarized in FIG. 32.

Various embodiments of the invention have been described. These and other embodiments are within the scope of the following claims.

1. A hot melt adhesive, comprising:
a poly(lactide) homopolymer or copolymer with a molecular weight of about 1000 to about 40000 Daltons; and
a plasticizer comprising an ester with about 50% to about 100% bio-based content; wherein the viscosity of the hot melt adhesive composition is about 500 to about 15,000 cPs at 350° F., and wherein the hot melt adhesive composition is substantially free of tackifying resins.

2. The hot melt adhesive of claim 1, wherein the plasticizer comprises an ester with 99% bio-based content.

3. The hot melt adhesive of claim 1, wherein the poly(lactide) comprises (L-lactide), (D-lactide), and (meso-lactide) monomeric units.

4. The hot melt adhesive of claim 1, wherein the poly(lactide) comprises poly(L-lactide, PLLA) or poly(D-lactide, PDLA).

5. The hot melt adhesive of claim 1, wherein the poly(lactide) is a homopolymer or a copolymer comprising a predominant amount of L-lactide and D-lactide monomeric units.

6. The hot melt adhesive of claim 1, wherein the poly(lactide) is a homopolymer comprising L-lactide monomeric units.

7. The hot melt adhesive of claim 1, further comprising about 1 wt % to about 25% of an epoxy resin.

8. A hot melt adhesive, comprising:
60 wt % to 99 wt % of a poly(lactide) homopolymer or copolymer with a molecular weight of about 1000 to about 40000 Daltons;
1 wt % to 40% wt % of a plasticizer comprising an ester with about 50% to about 99% bio-based content; and
1 wt % to 25 wt % of an epoxy resin.

9. The hot melt adhesive of claim 8, wherein the plasticizer comprises 99% bio-based content.

10. The hot melt adhesive of claim 8, wherein the poly(lactide) is a homopolymer or a copolymer comprising a predominant amount of L-lactide and D-lactide monomeric units.

11. The hot melt adhesive of claim 8, wherein the poly(lactide) is a homopolymer comprising L-lactide monomeric units.

12. A hot melt adhesive composition comprising:
60 wt % to 99 wt % of a poly(lactide) homopolymer or copolymer;
1 wt % to 40% wt % of a plasticizer comprising an ester with about 50% to about 99% bio-based content;
0 wt % to 25 wt % of an epoxy resin; and
0.1 wt % to 10 wt % of a molecular weight reducing compound selected from weak organic acids, amines, strong bases, alcohols, lewis acids and combinations thereof, wherein the hot melt adhesive is substantially free of tackifying resins.

13. The hot melt adhesive composition of claim 12, wherein the poly(lactide) is a homopolymer or a copolymer comprising a predominant amount of L-lactide and D-lactide monomeric units.

14. The hot melt adhesive composition of claim 12, wherein the poly(lactide) is a homopolymer comprising L-lactide monomeric units.

15. The hot melt adhesive composition of claim 12, wherein the weak organic acid is selected from the group consisting of citric acid, oxalic acid, adipic acid, undecanoic acid, p-toluenesulfonic acid, stearic acid, and combinations thereof.

16. The hot melt adhesive composition of claim 15, wherein the weak organic acid comprises citric acid.

17. The hot melt adhesive composition of claim 12, wherein the plasticizer comprises 99% bio-based content.

18. The hot melt adhesive composition of claim 12, comprising about 1 wt % to about 15 wt % of the epoxy resin.

19. The hot melt adhesive composition of claim 12, comprising about 5 wt % to about 10 wt % of the epoxy resin.

20. A method for making a hot melt adhesive, comprising:
heating to a temperature of 180° C. to 210° C. a hot melt adhesive composition comprising:
60 wt % to 99 wt % of a poly(lactide) homopolymer or copolymer;
1 wt % to 40% wt % of a plasticizer comprising an ester with about 50% to about 99% bio-based content; and
0.1 wt % to 10 wt % of a molecular weight reducing compound selected from weak organic acids, amines, lewis acids, bases and combinations thereof.

21. The method of claim 20, wherein the hot melt adhesive composition is heated for a time sufficient to provide the hot melt adhesive with a viscosity of about 1000 to about 15,000 cPs at 350° F.

22. The method of claim 21, wherein the hot melt adhesive precursor composition is heated for about 0.1 to about 2 hours.

23. The method of claim 20, wherein the molecular weight reducing compound is a weak organic acid.

24. The method of claim 23, wherein the weak organic acid is selected from the group consisting of citric acid, oxalic acid, adipic acid, undecanoic acid, p-toluenesulfonic acid, stearic acid, and combinations thereof.

25. The method of claim 24, wherein the weak organic acid is citric acid.

26. The method of claim 20, wherein the hot melt adhesive composition further comprises about 1 wt % to about 25 wt % of an epoxy resin.

27. A method comprising applying the hot melt adhesive of claim 8 to a substrate.
